(19) United States
(12) Patent Application Publication
(10) Pub. No.: US 2026/0100795 A1
(43) Pub. Date: Apr. 9, 2026

(54) METHOD FOR DEMODULATION REFERENCE SIGNAL CONFIGURATION AND RESOURCE MAPPING

(71) Applicant: Google LLC, Mountain View, CA (US)

(72) Inventor: Yushu Zhang, Beijing (CN)

(21) Appl. No.: 19/114,764

(22) PCT Filed: Sep. 30, 2022
(86) PCT No.: PCT/CN2022/123637

§ 371 Date: Mar. 24, 2025

(51) Int. Cl. H04L 5/00; H04W 72/21; H04W 72/232

(52) U.S. Cl. CPC H04L 5/0051; H04W 72/21; H04W 72/232

(57) ABSTRACT

This disclosure provides systems, devices, apparatus, and methods, including computer programs encoded on storage media, for DMRS configuration. A UE receives (904) control signaling that causes the UE to enable at least one of: a number of eType1 or eType2 DMRS antenna ports, a minimal FD-OCC de-spreading length, or at least one orphan RE handling scheme. The UE receives (306) DCI that schedules a physical shared channel for at least one of: at least one indicated eType1/eType2 DMRS antenna port, an indicated FD-OCC de-spreading length, or an indicated orphan RE handling scheme. The UE communicates (911) with the network entity on the physical shared channel based on at least one of: the at least one indicated eType1/eType2 DMRS antenna port, the indicated FD-OCC de-spreading length, or the indicated orphan RE handling scheme.

### TECHNICAL FIELD

The present disclosure relates generally to wireless communication, and more particularly, to demodulation reference signal (DMRS) configuration.

### BACKGROUND

The Third Generation Partnership Project (3GPP) specifies a radio interface referred to as fifth generation (5G) new radio (NR) (5G NR). An architecture for a 5G NR wireless communication system can include a 5G core (5GC) network, a 5G radio access network (5G-RAN), a user equipment (UE), etc. The 5G NR architecture might provide increased data rates, decreased latency, and/or increased capacity compared to other types of wireless communication systems.

Wireless communication systems, in general, may be configured to provide various telecommunication services (e.g., telephony, video, data, messaging, broadcasts, etc.) based on multiple-access technologies, such as orthogonal frequency division multiple access (OFDMA) technologies, that support communication with multiple UEs. As mobile broadband technologies evolve, improvements in mobile broadband have been useful to continue the progression of such technologies. For example, 3GPP recently introduced support for more antenna ports with higher order frequency-domain orthogonal cover codes (FD-OCC) in order to support higher order multi-use multiple-input multiple-output (MU-MIMO) configurations but certain configurations might result in a degradation of system performance.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

This disclosure describes methods and systems for configuring uplink and downlink enhanced Type1 (eType1) and eType2 demodulation reference signal (DMRS). Wireless receivers (e.g., a user equipment (UE) in some situations or a base station (BS), or network entity of a BS, in other situations) use downlink DMRS provided by the network entity of the BS and uplink DMRS provided by the UE to estimate the radio channel. After the receiver estimates the radio channel, the receiver decodes a data channel based on the radio channel estimation.

A resource block (RB) as defined by 3GPP standards includes 144 resource elements (REs) that can provide communication resources for UEs. In previous 3GPP releases, for example Release 15. Type 1 DMRS supports two code-domain orthogonal groups (e.g., code division multiplexing (CDM) group 0 and CDM group 1) and Type 2 DMRS supports three groups (CDM groups 0, 1, and 2). To distinguish antenna ports, DMRS has two frequency-domain orthogonal cover codes (FD-OCC) (e.g., antenna port 0=1, antenna port 1=−1). In total, in Release 15, Type 1 DMRS supports 8 antenna ports, which corresponds to two CDM groups×two symbols associated with a time-domain orthogonal cover code (TD-OCC)×two FD-OCCs. Release 15 Type 2 DMRS supports 12 antenna ports, which corresponds to three CDM groups×two TD-OCCs×two FD-OCCs.

As demand for wireless data traffic increases, Release 18 introduces more antenna ports with a higher order FD-OCC in order to support higher order multi-use multiple-input multiple-output (MU-MIMO) configurations. Building upon Release, 15 Type 1 DMRS (e.g., 2 CDM groups and 2 TD-OCC), eType1 DMRS adds two FD-OCC to provide FD-OCC-4. In total, eType1 DMRS supports 16 antenna ports. Similarly. eType2 defines 3 CDM groups with FD-OCC-4 and TD-OCC-2. In total, eType2 DMRS supports 24 antenna ports.

However, eType1 and eType2 DMRS may incur some technical problems. Firstly, because eType1 and eType2 DMRS support a higher order of antenna ports, the overhead to indicate the antenna ports for the eType1 and eType2 DMRS increases. Secondly, because UE receivers might not have information about co-scheduled UEs when a base station transmitter uses MU-MIMO, a UE might apply maximum, FD-OCC-4, de-spreading. As a result, the UE can become inefficient, which can degrade the performance of the wireless system. Thirdly, applying FD-OCC-4 for every set of REs within a CDM group might result in remainder REs, which may be referred to as “orphan REs”, that include DMRS signals that do not support antenna ports. Consequently, orphan REs lead to a waste of resources as well as potential confusion in identifying antenna ports.

To overcome the above-described technical problems, the methods, and systems configure the UE to handle eType1 and eType2 DMRS including control signaling of the maximum number of DMRS antenna ports, an FD-OCC de-spreading length, and/or a type of orphan RE handling. For example, a UE of this disclosure may transmit a capability report to a serving BS indicating that the UE is capable of supporting eType1 and eType2 DMRS. In addition, the capability report might include a total maximum number of antenna ports supported by the UE and/or orphan REs handling schemes supported by the UE. After the UE transmits the capability report, the UE receives control signaling from the network entity. The UE can receive the control signaling via a radio resource control (RRC) message or downlink control information (DCI). The control signaling causes the UE to enable the eType1 and eType2 DMRS. Then, the UE communicates with the network entity on a physical shared channel according to the control signaling. The physical shared channel can be a physical uplink shared channel (PUSCH) or a physical downlink shared channel (PDSCH). When decoding PDSCH, the UE determines which antenna ports are being used, which de-spreading length to use, and how to handle orphan REs.

On the network side, in response to receiving a UE capability report, the serving BS configures the UE to enable the eType1 and eType2 DMRS. In these implementations, the network entity and the UE can communicate on either a PUSCH or a PDSCH (or both).

Accordingly, the methods and systems overcome the technical problems faced by the eType1 and eType2 DMRS. The methods and systems handle the issue of higher order FD-OCC overhead and orphan REs that can contribute to degraded system performance.

To the accomplishment of the foregoing and related ends, the one or more aspects correspond to the features hereinafter described and particularly pointed out in the claims. The one or more aspects may be implemented through any of an apparatus, a method, a means for performing the method, and/or a non-transitory computer-readable medium. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 illustrates a diagram of a wireless communications system including a plurality of network entities in communication over a plurality of cells.

FIG. 2A illustrates a diagram of an example of DMRS symbol locations for Type1 DMRS, according to some embodiments.

FIG. 2B illustrates a diagram of an example of DMRS symbol locations for Type2 DMRS, according to some embodiments.

FIG. 2C illustrates a diagram of an example of DMRS symbol locations for eType1 DMRS, according to some embodiments.

FIG. 2D illustrates a diagram of an example of DMRS symbol locations for eType2 DMRS, according to some embodiments.

FIG. 3 illustrates a signaling diagram of an example scenario in which user equipment (UE) and network entity exchanges messages and implement procedures for downlink eType1 and eType2 DMRS configuration and resource mapping, according to some embodiments.

FIG. 4 is a flow diagram illustrating an example method of downlink eType1 and eType2 DMRS configuration and resource mapping, implemented in a UE, according to some embodiments.

FIG. 5 is a flow diagram illustrating an example method of downlink eType1 and eType2 DMRS configuration and resource mapping, implemented in a network entity, according to some embodiments.

FIG. 6 illustrates a signaling diagram of an example scenario in which a UE and a network entity exchange messages and implement procedures for uplink eType1 and eType2 DMRS configuration and resource mapping, according to some embodiments.

FIG. 7 is a flow diagram illustrating an example method of uplink eType1 and eType2 DMRS configuration and resource mapping, implemented in a UE, according to some embodiments.

FIG. 8 is a flow diagram illustrating an example method of uplink eType1 and eType2 DMRS configuration and resource mapping, implemented in a network entity, according to some embodiments.

FIG. 9 illustrates a signaling diagram of an example scenario in which a UE and network entity exchange messages and implement procedures for uplink and downlink eType1 and eType2 DMRS configuration and resource mapping, according to some embodiments.

FIG. 10 is a flow diagram illustrating an example method of downlink and uplink eType1 and eType2 DMRS configuration and resource mapping, implemented in a UE, according to some embodiments.

FIG. 11 is a flow diagram illustrating an example method of downlink and uplink eType1 and eType2 DMRS configuration and resource mapping implemented in a network entity, according to some embodiments.

FIG. 12A illustrates a diagram of an example of DMRS symbol locations within orphan REs, according to some embodiments.

FIG. 12B illustrates a diagram of an example of DMRS symbol locations for overlapping de-spreading windows, according to some embodiments.

FIGS. 12C-12D illustrate example tables of PT-RS RE offset configurations for eType1/eType2 DMRS, according to some embodiments.

FIG. 12E illustrates a table of an example of a joint indication of DMRS ports and minimal FD-OCC de-spreading length, according to some embodiments.

FIG. 12F illustrates a table of an example of eType1 DMRS port(s) indications with single front-loaded symbol and a maximum number of indicated ports is {1}, according to some embodiments.

FIG. 12G illustrates a table of an example of eType1 DMRS ports indication with single front-loaded symbol and the candidate number of indicated ports is {1, 2, 4}, according to some embodiments.

FIG. 13 is a diagram illustrating an example of a hardware implementation for an example UE apparatus.

FIG. 14 is a diagram illustrating an example of a hardware implementation for one or more example network entities.

### DETAILED DESCRIPTION

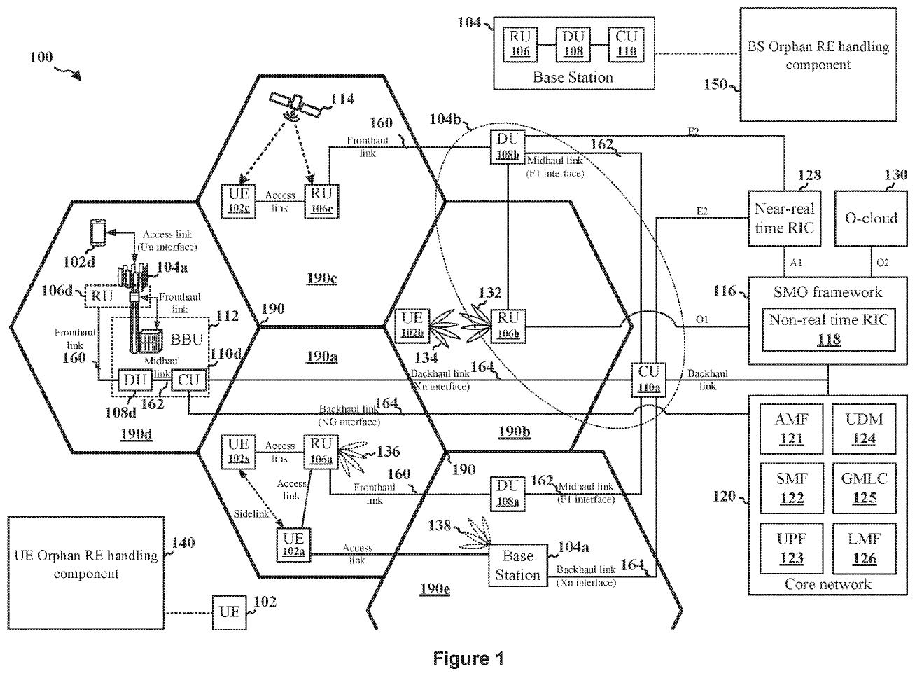

FIG. 1 illustrates a diagram 100 of a wireless communications system associated with a plurality of cells 190. The wireless communications system includes user equipments (UEs) 102 and base stations 104, where some base stations 104a include an aggregated base station architecture and other base stations 104b include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU).

Operations of the base stations 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN) which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the CU 110a communicates with the DUs 108a-108b via respective midhaul links based on F1 interfaces. The DUs 108a-108b may respectively communicate with the RU 106a and the RUs 106b-106c via respective fronthaul links. The RUs 106a-106c may communicate with respective UEs 102a-102c and 102s via one or more radio frequency (RF) access links based on a Uu interface. In examples, multiple RUs 106 and/or base stations 104 may simultaneously serve the UEs 102, such as the UE 102a of the cell 190a that the access links for the RU 106a of the cell 190a and the base station 104a of the cell 190e simultaneously serve.

One or more CUs 110, such as the CU 110a or the CU 110d, may communicate directly with a core network 120 via a backhaul link 164. For example, the CU 110d communicates with the core network 120 over a backhaul link 164 based on a next generation (NG) interface. The one or more CUs 110 may also communicate indirectly with the core network 120 through one or more disaggregated base station units, such as a near-real time RAN intelligent controller (RIC) 128 via an E2 link and a service management and orchestration (SMO) framework 116, which may be associated with a non-real time RIC 118. The near-real time RIC 128 might communicate with the SMO framework 116 and/or the non-real time RIC 118 via an A1 link. The SMO framework 116 and/or the non-real time RIC 118 might also communicate with an open cloud (O-cloud) 130 via an O2 link. The one or more CUs 110 may further communicate with each other over a backhaul link 164 based on an Xn interface. For example, the CU 110d of the base station 104a communicates with the CU 110a of the base station 104b over the backhaul link 164 based on the Xn interface. Similarly, the base station 104a of the cell 190e may communicate with the CU 110a of the base station 104b over a backhaul link 164 based on the Xn interface.

The RUs 106, the DUs 108, and the CUs 110, as well as the near-real time RIC 128, the non-real time RIC 118, and/or the SMO framework 116, may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as for the fronthaul link 160 between the RU 106d and the baseband unit (BBU) 112 of the cell 190d or, more specifically, the fronthaul link 160 between the RU 106d and DU 108d. The BBU 112 includes the DU 108d and a CU 110d, which may also have a wired interface configured between the DU 108d and the CU 110d to transmit or receive the information/signals between the DU 108d and the CU 110d based on a midhaul link 162. In further examples, a wireless interface, which may include a receiver, a transmitter, or a transceiver (such as an RF transceiver), can be configured to transmit or receive the information/signals via the wireless transmission medium, such as for information communicated between the RU 106a of the cell 190a and the base station 104a of the cell 190e via cross-cell communication beams of the RU 106a and the base station 104a.

One or more higher layer control functions, such as function related to radio resource control (RRC), packet data convergence protocol (PDCP), service data adaptation protocol (SDAP), and the like, may be hosted at the CU 110. Each control function may be associated with an interface for communicating signals based on one or more other control functions hosted at the CU 110. User plane functionality such as central unit-user plane (CU-UP) functionality, control plane functionality such as central unit-control plane (CU-CP) functionality, or a combination thereof may be implemented based on the CU 110. For example, the CU 110 can include a logical split between one or more CU-UP procedures and/or one or more CU-CP procedures. The CU-UP functionality may be based on bidirectional communication with the CU-CP functionality via an interface, such as an E1 interface (not shown), when implemented in an O-RAN configuration.

The CU 110 may communicate with the DU 108 for network control and signaling. The DU 108 is a logical unit of the base station 104 configured to perform one or more base station functionalities. For example, the DU 108 can control the operations of one or more RUs 106. One or more of a radio link control (RLC) layer, a medium access control (MAC) layer, or one or more higher physical (PHY) layers, such as forward error correction (FEC) modules for encoding/decoding, scrambling, modulation/demodulation, or the like can be hosted at the DU 108. The DU 108 may host such functionalities based on a functional split of the DU 108. The DU 108 may similarly host one or more lower PHY layers, where each lower layer or module may be implemented based on an interface for communications with other layers and modules hosted at the DU 108, or based on control functions hosted at the CU 110.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RUs 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134 of the UE 102b, which may correspond to inter-cell communication beams or cross-cell communication beams. Both real-time and non-real-time features of control plane and user plane communications of the RUs 106 can be controlled by associated DUs 108. Accordingly, the DUs 108 and the CUs 110 can be utilized in a cloud-based RAN architecture, such as a vRAN architecture, whereas the SMO framework 116 can be utilized to support non-virtualized and virtualized RAN network elements. For non-virtualized network elements, the SMO framework 116 may support deployment of dedicated physical resources for RAN coverage, where the dedicated physical resources may be managed through an operations and maintenance interface, such as an O1 interface. For virtualized network elements, the SMO Framework 116 may interact with a cloud computing platform, such as the O-cloud 130 via the O2 link (e.g., cloud computing platform interface), to manage the network elements. Virtualized network elements can include, but are not limited to, RUs 106, DUs 108, CUs 110, near-real time RICs 128, etc.

The SMO framework 116 may be configured to utilize an O1 link to communicate directly with one or more RUs 106. The non-real time RIC 118 of the SMO framework 116 may also be configured to support functionalities of the SMO framework 116. For example, the non-real time RIC 118 implements logical functionality that enables control of non-real time RAN features and resources, features/applications of the near-real time RIC 128, and/or artificial intelligence/machine learning (AI/ML) procedures. The non-real time RIC 118 may communicate with (or be coupled to) the near-real time RIC 128, such as through the A1 interface. The near-real time RIC 128 may implement logical functionality that enables control of near-real time RAN features and resources based on data collection and interactions over an E2 interface, such as the E2 interfaces between the near-real time RIC 128 and the CU 110a and the DU 108b.

The non-real time RIC 118 may receive parameters or other information from external servers to generate AI/ML models for deployment in the near-real time RIC 128. For example, the non-real time RIC 118 receives the parameters or other information from the O-cloud 130 via the O2 link for deployment of the AI/ML models to the real-time RIC 128 via the A1 link. The near-real time RIC 128 may utilize the parameters and/or other information received from the non-real time RIC 118 or the SMO framework 116 via the A1 link to perform near-real time functionalities. The near-real time RIC 128 and the non-real time RIC 115 may be configured to adjust a performance of the RAN. For example, the non-real time RIC 116 monitors patterns and long-term trends to increase the performance of the RAN. The non-real time RIC 116 may also deploy AI/ML models for implementing corrective actions through the SMO framework 116, such as initiating a reconfiguration of the O1 link or indicating management procedures for the A1 link.

Any combination of the RU 106, the DU 108, and the CU 110, or reference thereto individually, may correspond to a base station 104. Hence, the base station 104 may include at least one of the RU 106, the DU 108, or the CU 110. The base stations 104 provide the UEs 102 with access to the core network 120. That is, the base stations 104 might relay communications between the UEs 102 and the core network 120. The base stations 104 may be associated with macrocells for high-power cellular base stations and/or small cells for low-power cellular base stations. For example, the cell 190e corresponds to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104a of cell 190d to transmit a downlink/forward link communication to the UE 102d or receive an uplink/reverse link communication from the UE 102d based on the Uu interface associated with the access link between the UE 102d and the base station 104a/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating bands referred to as frequency range 1 (FR1) and frequency range 2 (FR2). FR1 ranges from 410 MHz-7.125 GHz and FR2 ranges from 24.25 GHz-52.6 GHz. Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz-24.25 GHz. Frequency bands within FR3 may include characteristics of FR1 and/or FR2. Hence, features of FR1 and/or FR2 may be extended into the mid-band frequencies. Higher operating bands have been identified to extend 5G NR communications above 52.6 GHz associated with the upper limit of FR2. Three of these higher operating bands include FR2-2, which ranges from 52.6 GHz-71 GHz, FR4, which ranges from 71 GHz-114.25 GHz, and FR5, which ranges from 114.25 GHz-300 GHz. The upper limit of FR5 corresponds to the upper limit of the EHF band. Thus, unless otherwise specifically stated herein, the term “sub-6 GHz” may refer to frequencies that are less than 6 GHz, within FR1, or may include the mid-band frequencies. Further, unless otherwise specifically stated herein, the term “millimeter wave”, or mmW, refers to frequencies that may include the mid-band frequencies, may be within FR2, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of beams 132 to the UE 102b in one or more transmit directions of the RU 106b. The UE 102b may receive the downlink beamformed signal based on a second set of beams 134 from the RU 106b in one or more receive directions of the UE 102b. In a further example, the UE 102b may also transmit an uplink beamformed signal to the RU 106b based on the second set of beams 134 in one or more transmit directions of the UE 102b. The RU 106b may receive the uplink beamformed signal from the UE 102b in one or more receive directions of the RU 106b. The UE 102b may perform beam training to determine the best receive and transmit directions for the beam formed signals. The transmit and receive directions for the UEs 102 and the base stations 104/RUs 106 might or might not be the same. In further examples, beamformed signals may be communicated between a first base station 104a and a second base station 104b. For instance, the RU 106a of cell 190a may transmit a beamformed signal based on an RU beam set 136 to the base station 104a of cell 190e in one or more transmit directions of the RU 106a. The base station 104a of the cell 190c may receive the beamformed signal from the RU 106a based on a base station beam set 138 in one or more receive directions of the base station 104a. Similarly, the base station 104a of the cell 190e may transmit a beamformed signal to the RU 106a based on the base station beam set 138 in one or more transmit directions of the base station 104a. The RU 106a may receive the beamformed signal from the base station 104a of the cell 190e based on the RU beam set 136 in one or more receive directions of the RU 106a.

The base station 104 may include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a transmit reception point (TRP), a network node, a network entity, network equipment, or other related terminology. The base station 104 or an entity at the base station 104 can be implemented as an JAB node, a relay node, a sidelink node, an aggregated (monolithic) base station with an RU 106 and a BBU that includes a DU 108 and a CU 110, or as a disaggregated base station 104b including one or more of the RU 106, the DU 108, and/or the CU 110. A set of aggregated or disaggregated base stations 104a-104b may be referred to as a next generation-radio access network (NG-RAN).

The core network 120 may include an Access and Mobility Management Function (AMF) 121, a Session Management Function (SMF) 122, a User Plane Function (UPF) 123, a Unified Data Management (UDM) 124, a Gateway Mobile Location Center (GMLC) 125, and/or a Location Management Function (LMF) 126. The core network 120 may also include one or more location servers, which may include the GMLC 125 and the LMF 126, as well as other functional entities. For example, the one or more location servers include one or more location/positioning servers, which may include the GMLC 125 and the LMF 126 in addition to one or more of a position determination entity (PDE), a serving mobile location center (SMLC), a mobile positioning center (MPC), or the like.

The AMF 121 is the control node that processes the signaling between the UEs 102 and the core network 120. The AMF 121 supports registration management, connection management, mobility management, and other functions. The SMF 122 supports session management and other functions. The UPF 123 supports packet routing, packet forwarding, and other functions. The UDM 124 supports the generation of authentication and key agreement (AKA) credentials, user identification handling, access authorization, and subscription management. The GMLC 125 provides an interface for clients/applications (e.g., emergency services) for accessing UE positioning information. The LMF 126 receives measurements and assistance information from the NG-RAN and the UEs 102 via the AMF 121 to compute the position of the UEs 102. The NG-RAN may utilize one or more positioning methods in order to determine the position of the UEs 102. Positioning the UEs 102 may involve signal measurements, a position estimate, and an optional velocity computation based on the measurements. The signal measurements may be made by the UEs 102 and/or the serving base stations 104/RUs 106.

Communicated signals may also be based on one or more of a satellite positioning system (SPS) 114, such as signals measured for positioning. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

The UEs 102 may be configured as a cellular phone, a smart phone, a session initiation protocol (SIP) phone, a laptop, a personal digital assistant (PDA), a satellite radio, a GPS, a multimedia device, a video device, a digital audio player (e.g., moving picture experts group (MPEG) audio layer-3 (MP3) player), a camera, a game console, a tablet, a smart device, a wearable device, a vehicle, an utility meter, a gas pump, appliances, a healthcare device, a sensor/actuator, a display, or any other device of similar functionality. Some of the UEs 102 may be referred to as Internet of Things (IoT) devices, such as parking meters, gas pumps, appliances, vehicles, healthcare equipment, etc. The UE 102 may also be referred to as a station (STA), a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a mobile client, a client, or other similar terminology. The term UE may also apply to a roadside unit (RSU), which may communicate with other RSU UEs, non-RSU UEs, a base station 104, and/or an entity at a base station 104, such as an RU 106.

Still referring to FIG. 1, in certain aspects, the UE 102 may include a UE Orphan resource element (RE) handling component 140 configured to receive, from a network entity, control signaling that causes the UE to enable at least one of: a number of enhanced Type1 (eType1) or eType2 demodulation reference signal (DMRS) antenna ports, a minimal frequency-domain orthogonal cover codes (FD-OCC) de-spreading length, or at least one orphan RE handling scheme; receive, from the network entity, downlink control information (DCI) that schedules a physical shared channel for at least one of: at least one indicated eType1/eType2 DMRS antenna port, an indicated FD-OCC de-spreading length, or an indicated orphan RE handling scheme; and communicate with the network entity on the physical shared channel based on at least one of: the at least one indicated eType1/eType2 DMRS antenna port, the indicated FD-OCC de-spreading length, or the indicated orphan RE handling scheme.

In certain aspects, the base station 104 or a network entity of the base station 104 may include a BS Orphan RE handling component 150 configured to transmitting, to a UE, control signaling that causes the UE to enable at least one of: a number of eType1 or eType2 DMRS antenna ports, a minimal FD-OCC de-spreading length, or at least one orphan RE handling scheme; transmit, to the UE, DCI that schedules a physical shared channel for the at least one of: the eType1 DMRS, at least one indicated eType1/eType2 DMRS antenna port, an indicated FD-OCC de-spreading length, or an indicated orphan RE handling scheme; and communicate with the UE on the physical shared channel based on at least one of: the at least one indicated eType1/eType2 DMRS antenna ports, the indicated FD-OCC de-spreading length, or the indicated orphan RE handling scheme.

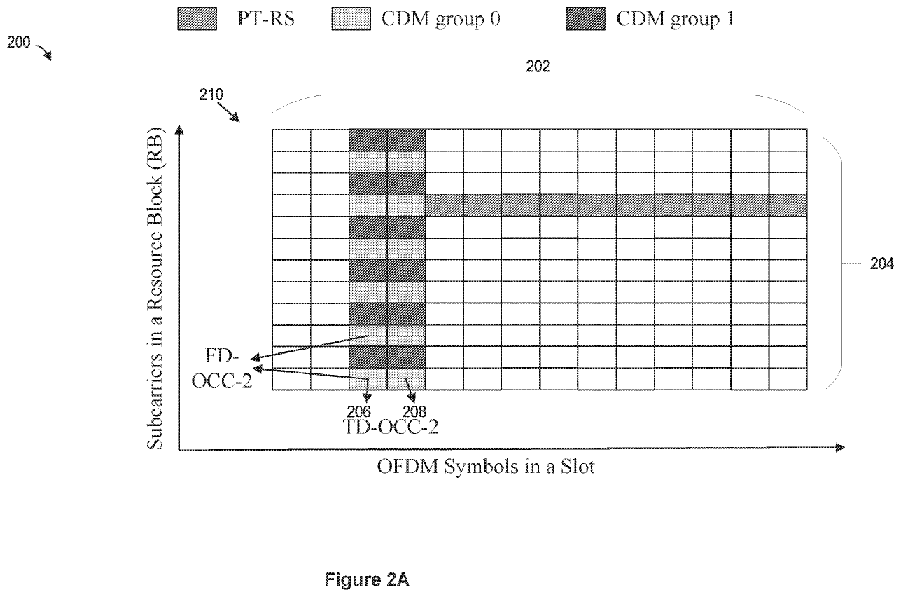

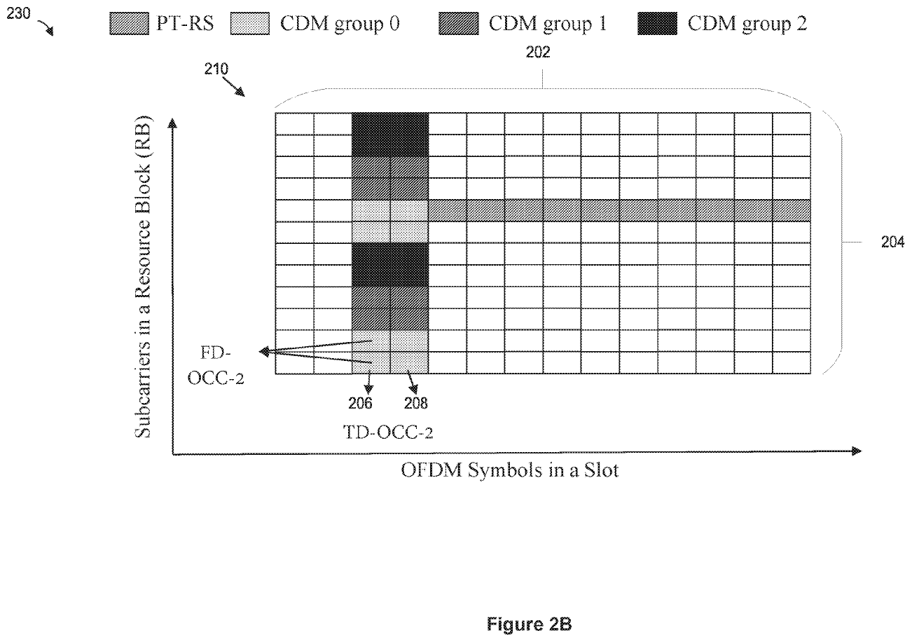

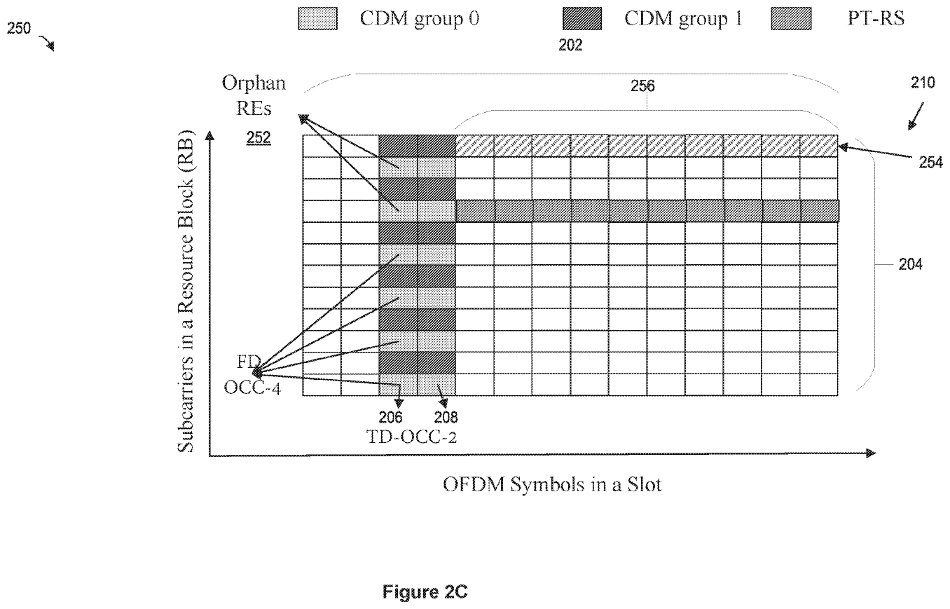

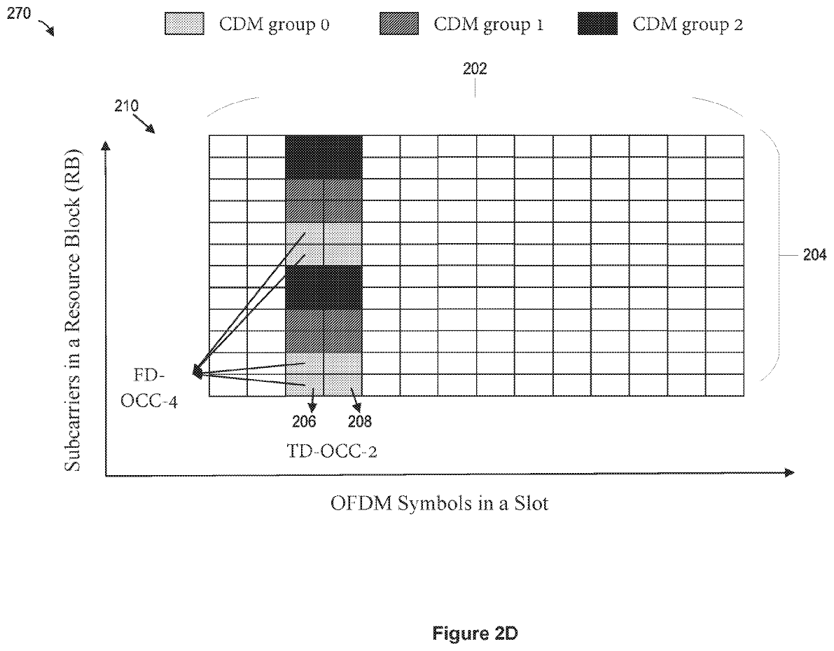

Accordingly, FIG. 1 describes a wireless communication system that may be implemented in connection with aspects of one or more other figures described herein, such as aspects illustrated in FIGS. 2A-14. Further, although the following description may be focused on 5G NR, the concepts described herein may be applicable to other similar areas, such as 5G-Advanced and future versions, LTE, LTE-advanced (LTE-A), and other wireless technologies.

FIG. 2A is a diagram 200 illustrating an example of DMRS symbol locations for Type1 DMRS. A resource block (RB) 210 consists of 12 subcarriers 204 and this example shows an RB with 14 symbols 202. Type 1 DMRS supports up to 8 antenna ports with up to 2 front-loaded DMRS symbols 206, 208 (e.g., time-domain orthogonal cover codes (TD-OCC) 2) and 2 Code Division Multiplexing (CDM) groups (e.g., CDM group 0 and CDM group 1). Front-loaded DMRS mean that the signals occur early in the transmission. In FIG. 2A, every two consecutive subcarriers within a CDM group (e.g., CDM group 0) applies a FD-OCC with a length of 2. Two DMRS symbols within a CDM group (e.g., CDM group 0) applies time-domain orthogonal cover code (TD-OCC) with a length of 2.

FIG. 2B is a diagram 230 illustrating an example of DMRS symbol locations for Type2 DMRS. Type 2 DMRS supports up to 12 ports with up to 2 front-loaded DMRS symbols 206,208 (e.g., TD-OCC 2) and 3 Code Division Multiplexing (CDM) groups (e.g., CDM group 0, CDM group 1, and CDM group 2). As shown in FIG. 2B, every two consecutive subcarriers within a CDM group applies FD-OCC of length 2. Two DMRS symbols applies time-domain orthogonal cover code (TD-OCC) with a length of 2.

Different DMRS ports can occupy different CDM groups, different FD-OCC, or different TD-OCC. A resource element in subcarrier k, symbol l for DMRS port p is generated as follows:

$${a}_{k , l}^{p} = β {w}_{f} ( {k}^{′} ) {w}_{t} ( {l}^{′} ) r ( 2 n + {k}^{′} )$$

$${k}^{′} = 0 , 1$$

$$l = \overline{l} + {l}^{′}$$

$$n = 0 , 1 , …$$

where, k=4n+2k′+Δ for DMRS Type 1 and k=6n+k′+Δ for DMRS type 2; l̅ is the first symbols index allocated for DMRS; Δ is the subcarrier offset for current CDM group for port p, Δ=0, 1 for CDM group 1 and 2 respectively for DMRS type1 and Δ=0, 2, 4 for CDM group 1 and 2 respectively for DMRS Type1; r( ) is the base sequence for DMRS, which is generated based on a QPSK sequence as defined in 3GPP TS 38.211 section 6.4.1.1.1 and 7.4.1.1.1; w_{f} is the FD-OCC, and it can be either [1, 1] or [1, −1], which depends on the DMRS port index; wₜ is the TD-OCC, and it can be either [1, 1] or [1, −1], which depends on the DMRS port index; l′=0, 1 for two front-loaded symbols based DMRS and l′=0 for single front-loaded symbol based DMRS, i.e. TD-OCC is disabled.

For a UE with a smaller number of layers and with a low-order of MU-MIMO operation or SU-MIMO operation, some CDM groups can be used for data transmission. The network entity can use the scheduling DCI to indicate the number of CDM groups without data. If the number of CDM groups without data is smaller than the maximum number of CDM groups for the DMRS type, the resource elements reserved for the remaining CDM group(s) can be used for data transmission.

In Release 18, to support higher order MU-MIMO, more DMRS ports are introduced with higher order FD-OCC, e.g. FD-OCC 4. FIG. 2C illustrates an example for FD-OCC-4 based enhanced DMRS type 1 (eType1), and FIG. 2D illustrates an example for FD-OCC-4 based enhanced DMRS type 2 (eType2). Such enhanced DMRS structure can create more orthogonal DMRS ports so as to increase the MU-MIMO order for both PDSCH and PUSCH. In one example, 4 FD-OCC sequences {[1, 1, 1, 1], [1, −1, 1, −1], [−1, −1, 1, 1], [1, −1, −1, 1} can be defined to create 4 orthogonal ports.

FIG. 2C is a diagram 250 illustrating an example of DMRS symbol locations for eType1 DMRS. eType 1 DMRS supports up to 16 ports with up to 2 front-loaded DMRS symbols 206,208 (e.g., TD-OCC 2) and 2 Code Division Multiplexing (CDM) groups (e.g., CDM group 0 and CDM group 1). In FIG. 2C, every four consecutive subcarriers within a CDM group (e.g., CDM group 0) applies a FD-OCC with a length of 4. Two DMRS symbols within a CDM group (e.g., CDM group 0) applies time-domain orthogonal cover code (TD-OCC) with a length of 2. For eType1 DMRS, when every four consecutive subcarriers within a CDM group apply FD-OCC with a length 4, two REs cannot find another two resource elements. These two REs are called orphan REs 252. In FIG. 2C, a UE is scheduled with 1 RB 210 and the UE cannot identify another 2 REs for the last 2 REs in a CDM group with a complete FD-OCC sequence for FD-OCC-4 decoding.

FIG. 2D is a diagram 270 illustrating an example of DMRS symbol locations for eType2 DMRS. eType 2 DMRS supports up to 24 ports with up to 2 front-loaded DMRS symbols 206,208 (e.g., TD-OCC 2) and 3 Code Division Multiplexing (CDM) groups (e.g., CDM group 0. CDM group 1, and CDM group 2). In FIG. 2D, every four consecutive subcarriers within a CDM group (e.g., CDM group 0) applies a FD-OCC with a length of 4.

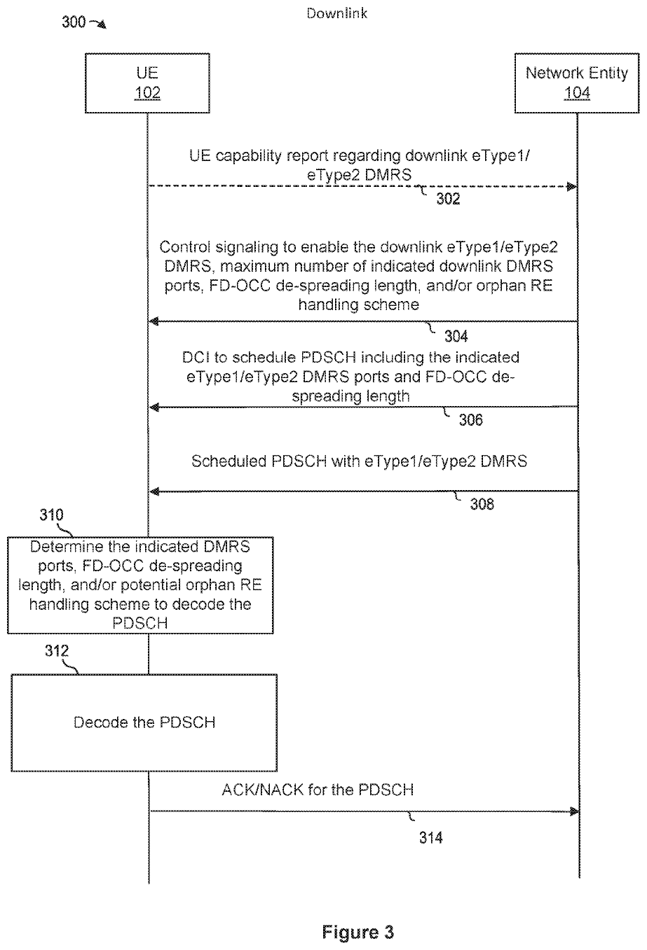

FIGS. 2A-2D illustrate examples of DMRS symbol locations for Type1 DMRS/Type2 DMRS/eType1 DMRS/eType2 DMRS. As noted with respect to FIG. 2C, some eType1 DMRS configurations result in orphan REs 252, which may contain DMRS signals that do not support antenna ports. Additionally, if a DMRS receiver is not aware of the FD-OCC value, the receiver might apply a minimal de-spreading value defaulted to FD-OCC-4 but this would be inefficient when the FD-OCC value is greater than the minimal. Thus, FIG. 3 illustrates a signaling diagram of an example scenario in which user equipment (UE) and network entity exchanges messages and implement procedures for downlink eType1 and eType2 DMRS configuration and resource mapping to address these technical concerns.

FIG. 3 is a signaling diagram 300 of an example scenario in which UE and network entity exchanges messages and implement procedures for downlink eType1 and eType2 DMRS configuration and resource mapping, according to some embodiments. Initially, the UE 102 may transmit 302, to a serving network entity 104, a UE capability report regarding downlink eType1/eType2 DMRS. The UE capability report may include one or more UE capabilities indicating that the UE 102 supports at least one of: a total number of eType1/eType2 DMRS antenna ports, a set of FD-OCC de-spreading lengths, eType1 DMRS and/or eType2 DMRS, or at least a first orphan RE handling scheme. The total number of antenna ports reported by the UE may indicate at least one of: a maximum number of antenna ports; or a candidate number of antenna ports. For example, the UE can indicate to the network entity a candidate number of antenna ports as {1, 2, 4}. The UE can indicate to the network entity that the maximum number of antenna ports is a single value, for example, 4.

As an alternative to over-the-air UE capability reporting, the network entity 104 may receive the one or more UE capabilities from a core network entity, such as an AMF. Based on the one or more UE capabilities, the network entity 104 enables the downlink/uplink eType1/eType2 DMRS, a number of indicated ports, and orphan RE handling schemes. In an example, the network entity 104 may enable the downlink/uplink eType1/eType2 DMRS through an RRC higher layer parameters, such as DMRS-DownlinkConfig for downlink and DMRS-UplinkConfig for uplink.

The UE 102 receives 304, from the network entity 104, control signaling that causes the UE 102 to enable at least one of: a number of eType1 or eType2 DMRS antenna ports, a minimal FD-OCC de-spreading length, or at least one orphan RE handling scheme.

After that, the UE 102 receives 306 from the network entity 104 a DCI that schedules a physical shared channel for the at least one of: at least one indicated eType1/eType2 DMRS antenna port, an indicated FD-OCC de-spreading length, or the indicated orphan RE handling scheme, the eType1 DMRS and the eType2 DMRS associated with DMRS antenna ports. For example, the network entity schedules a PDSCH via the DCI. The network entity may use the PDSCH to communicate user data with the UE. For example, user data includes voice data, video data, etc. The DCI includes an indication of the scheduled eType1/eType2 DMRS ports, and co-scheduled UE(s) information.

Then, the UE 102 receives 308 a scheduled PDSCH based on the control signaling and DCI. The UE 102 determines 310 the at least one indicated eType1/eType2 DMRS antenna ports, the indicated FD-OCC de-spreading length, or the indicated orphan RE handling scheme. The UE 102 decodes 312 the PDSCH according to the control signaling and DCI. The UE 102 may transmit 314 acknowledgment/negative acknowledgment (ACK/NACK) feedback to the network entity 104 responsive to decoding 312 the PDSCH.

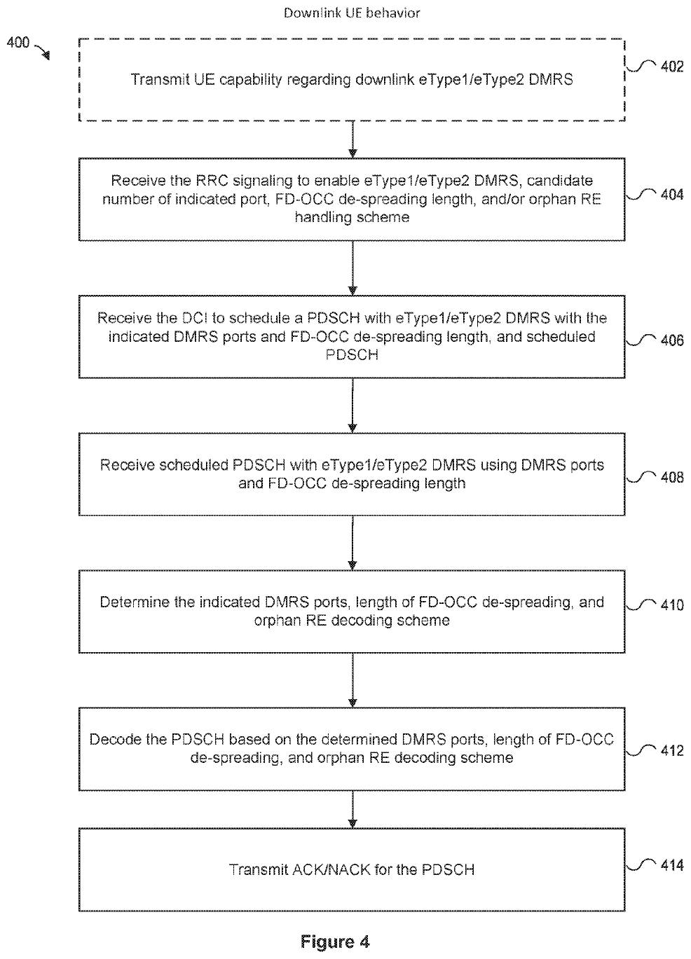

FIG. 3 describes a signaling diagram of an example scenario in which a user equipment (UE) and a network entity exchange messages and implement procedures for downlink eType1 and eType2 DMRS configuration and resource mapping, and FIG. 4 describes a method from a UE-side of the wireless communication link. Example method 400 focuses on a UE method for downlink eType1/eType2 DMRS configuration and resource mapping. The method 400 can be implemented by a UE 102 communicating with a network entity 104 depicted in FIG. 1. With reference to FIGS. 1-3 and 13, the method may be performed by the UE 102, the UE apparatus 1300, etc., which may include the memory 1324′ and which may correspond to the entire UE 102 or the UE apparatus 1300, or a component of the UE 102 or the UE apparatus 1300, such as the wireless baseband processor 1324, and/or the application processor 1306.

The method 400 begins at block 402 where the UE 102 may transmit a UE capability report message on downlink eType1/eType2 DMRS. The UE capability report message can represent the transmission 302 as shown in FIG. 3.

Next, at block 404, the UE 102 receives RRC signaling to enable eType1/eType2 DMRS, a maximum number of indicated eType1/eType2 DMRS ports, a minimal FD-OCC de-spreading length corresponding to at least one set of indicated Type1/eType2 DMRS port(s), and/or at least one orphan RE handling scheme. For example, referring to FIG. 3, the UE 102 receives 304 from the network entity 104, control signaling that causes the UE 102 to enable at least one of: a number of eType1 or eType2 DMRS antenna ports, a minimal FD-OCC de-spreading length, or at least one orphan RE handling scheme.

At block 406, the UE 102 receives the DCI to schedule a PDSCH with eType1/eType2 DMRS with the indicated DMRS ports and indicated minimal FD-OCC de-spreading length, as well as PDSCH scheduling information. For example, referring to FIG. 3, the UE 102 receives 306 DCI to schedule PDSCH. At block 408, the UE 102 receives scheduled PDSCH with eType1/eType2 DMRS using DMRS ports, FD-OCC de-spreading length, and PDSCH resources indicated in the DCI. For example, referring to FIG. 3, UE 102 receives 308 PDSCH signals with eType1/eType2 DMRS using DMRS ports and FD-OCC de-spreading length.

At block 410, the UE 102 determines the indicated DMRS ports, length of FD-OCC de-spreading, and orphan RE decoding scheme as needed. For example, referring to FIG. 3, the UE 102 determines 310 the indicated DMRS ports, FD-OCC de-spreading length, and/or potential orphan RE handling scheme.

At block 412, the UE 102 might decode the PDSCH based on the determined DMRS ports, length of FD-OCC de-spreading, and orphan RE decoding scheme. For example, referring to FIG. 3, the UE 102 decodes 312 the PDSCH.

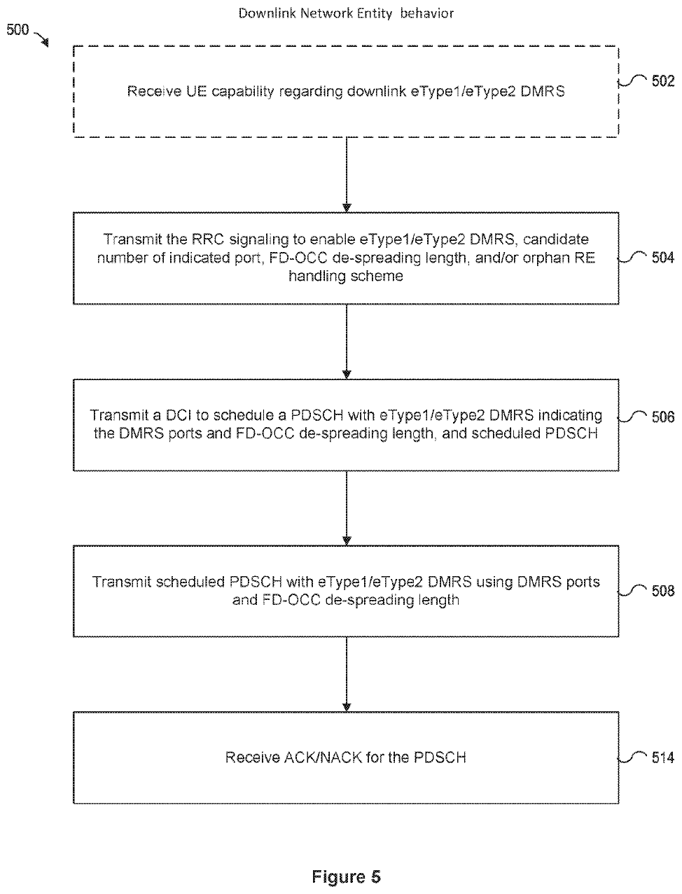

At block 414, the UE 102 might transmit ACK/NACK feedback for the PDSCH. For example, referring to FIG. 3, the UE 102 transmits 314 ACK/NACK feedback to the network entity for the PDSCH. FIG. 4 describes a method from a UE-side of a wireless communication link, whereas FIG. 5 describes a method from a network-side of the wireless communication link.

Now turn to FIG. 5 which illustrates an example method 500 for downlink eType1/eType2 DMRS configuration and resource mapping implemented in the network entity. The method 500 can be implemented by network entity 104 depicted in FIG. 1. With reference to FIGS. 1-3 and 14, the method 500 may be performed by the base station or one or more network entities 104 at the base station, which may correspond to the RU 106, the DU 108, the CU 110, an RU processor 1442, a DU processor 1432, a CU processor 1412, etc. The base station or the one or more network entities 104 at the base station may include the memory 1412′/1432′/1442′, which may correspond to an entirety of the one or more network entities 104 or the base station, or a component of the one or more network entities 104 or the base station.

The method 500 begins at block 502 in which the base station or the one or more network entities 104 at the base station may receive a UE capability report message regarding downlink eType1/eType2 DMRS. For example, referring to FIG. 3, the base station or the one or more network entities 104 at the base station receives 302 a UE capability report message regarding downlink eType1/eType2 DMRS.

At block 504, the BS Orphan RE handling component 150 of the base station or the one or more network entities 104 at the base station, such as the RU 106, the DU 108, and/or the CU 110 transmits control signaling to enable downlink eType1/eType2 DMRS, a maximum number or candidate number of indicated ports, a minimal FD-OCC de-spreading length, and/or one or more orphan RE handling schemes. For example, referring to FIG. 3, the base station or the one or more network entities 104 at the base station transmits 304 RRC control signaling to enable downlink eType1/eType2 DMRS, a candidate number of indicated ports, an FD-OCC-2 minimal de-spreading length, and two orphan RE handling schemes. The network entity 104 may transmit RRC signaling that indicates an RRC reconfiguration message or the network entity 104 may transmit a system information block (SIB), where the SIB can be a predefined SIB (e.g., SIB1) or a different SIB (e.g., SIB J, where J corresponds to an integer greater than 21).

At block 506, the network entity 104 transmits a DCI to schedule a PDSCH with eType1/eType2 DMRS indicating the DMRS ports and FD-OCC de-spreading length, and scheduled PDSCH resources. For example, referring to FIG. 3, the base station or the one or more network entities 104 at the base station transmits 306 a DCI to schedule a PDSCH.

At block 508, the network entity 104 transmits scheduled PDSCH with eType1/eType2 DMRS using DMRS ports, FD-OCC de-spreading length, and PDSCH resources indicated in the DCI. For example, referring to FIG. 3, the base station or the one or more network entities 104 at the base station transmits 308 PDSCH signals with eType1/eType2 DMRS using DMRS ports and FD-OCC de-spreading length.

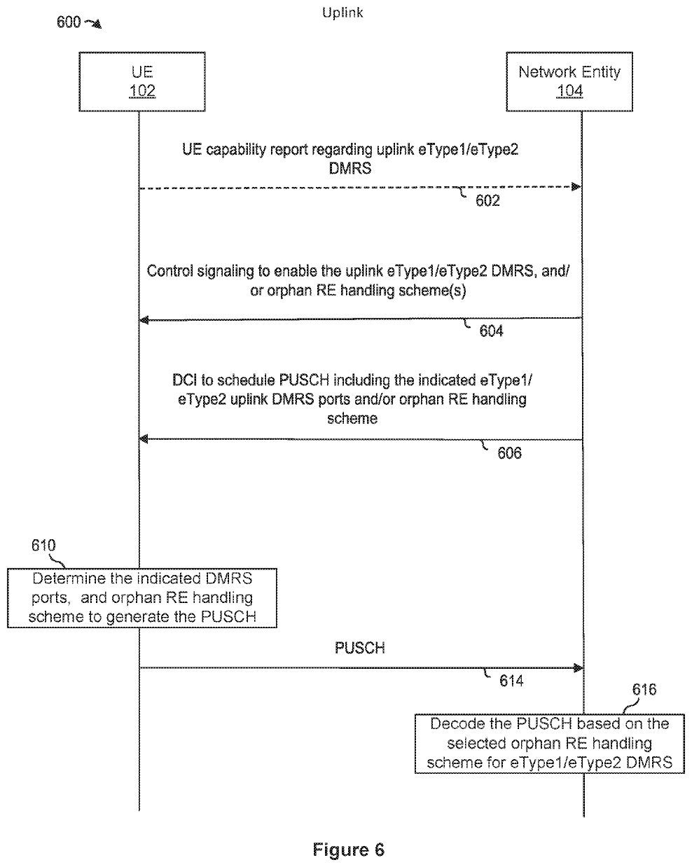

In response, at block 514, the network entity 104 might receive ACK/NACK feedback for the PDSCH message. For example, referring to FIG. 3, the base station or the one or more network entities 104 at the base station receives 314 ACK/NACK feedback for the PDSCH message. FIGS. 3-5 describe a method for a downlink communication of the wireless communication link, whereas FIG. 6 is a signaling diagram of an example scenario in which a user equipment (UE) and a network entity exchange messages and implement procedures for uplink Type1 and Type2 DMRS configuration and resource mapping.

FIG. 6 is a signaling diagram 600 illustrating communications between a UE 102 and a network entity 104 for uplink eType1 and eType2 DMRS configuration and resource mapping. The network entity 104 may correspond to the base station or an entity at the base station, such as the RU 106, the DU 108, the CU 110, etc.

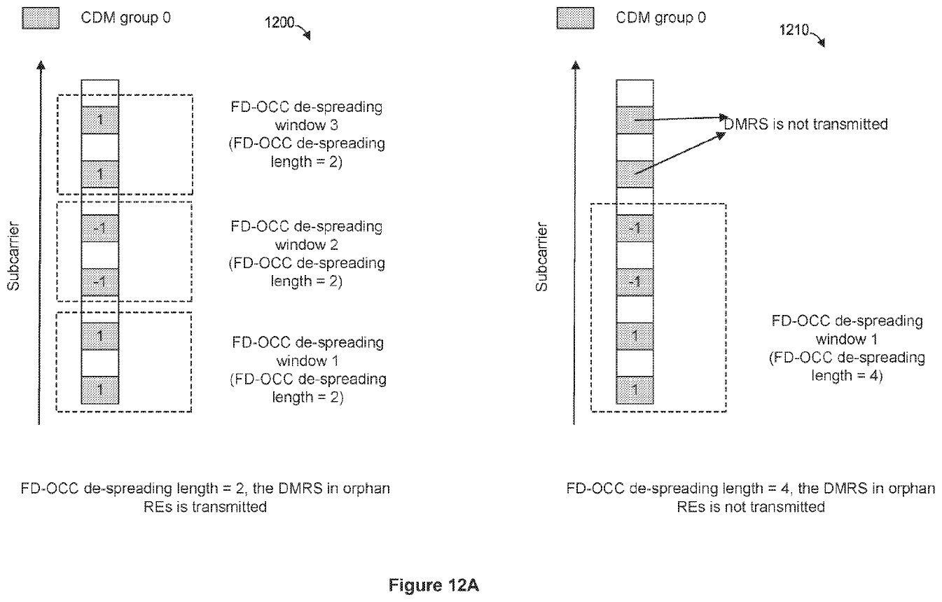

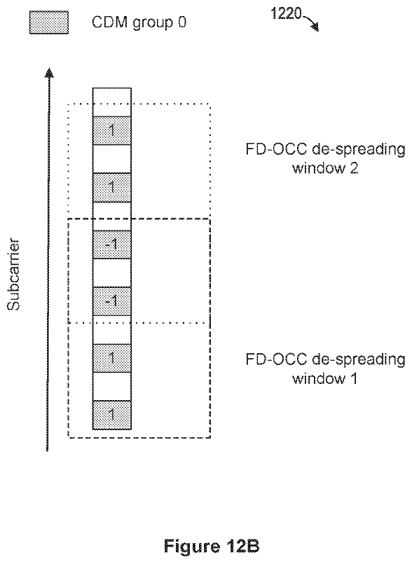

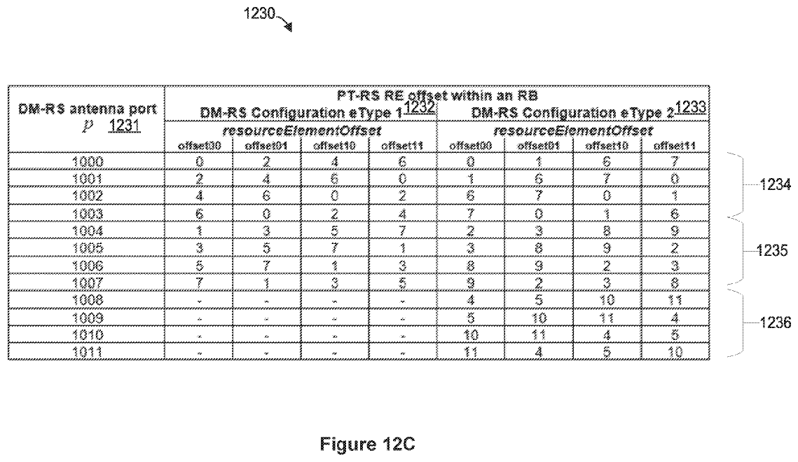

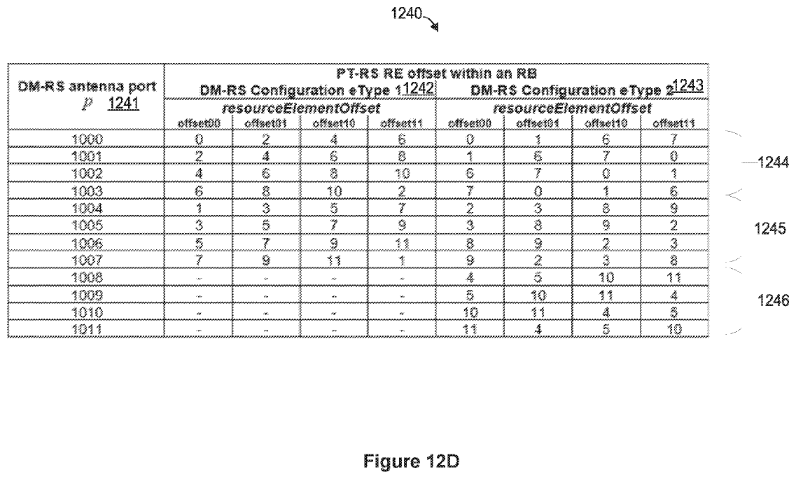

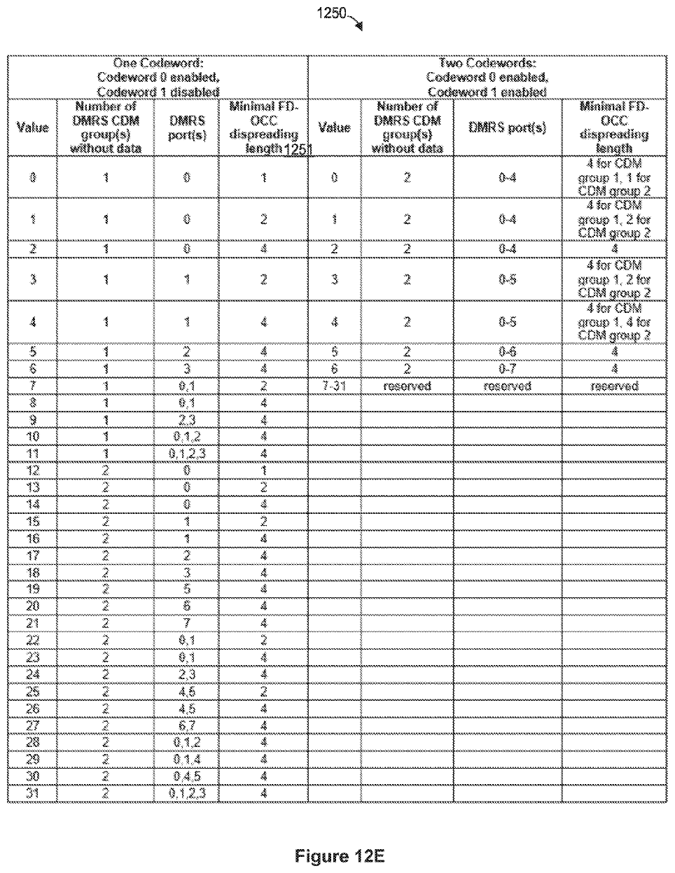

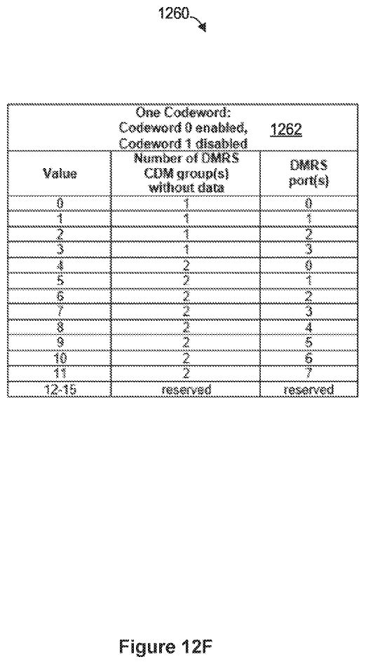

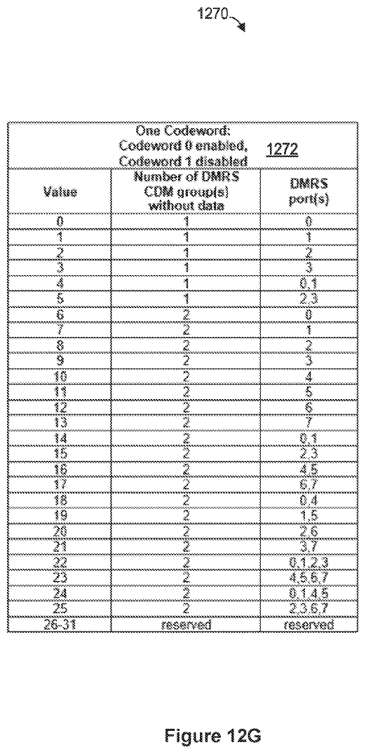

Unlike the downlink eType1/eType2 DMRS configuration described above, the control signaling for uplink eType1/eTYpe2 DMRS does not include the FD-OCC de-spreading length. The network entity has information on the scheduling status of co-scheduled UE(s) and, hence, the network entity determines the FD-OCC de-spreading length. Therefore, in the orphan RE handling scheme (to be discussed with reference to FIGS. 12A-12B), the network entity only needs to indicate to the UE how to transmit the DMRS in orphan REs and the corresponding PUSCH. For example, the network entity may indicate to the UE whether to transmit the DMRS, user data, or nothing in the orphan REs. In some implementations, a DCI may indicate whether to transmit the DMRS in the orphan REs.

In some aspects, the network entity may use a DCI to indicate whether DMRS shall be transmitted in the orphan REs when the network entity schedules a PUSCH message. In one example, the network entity may indicate whether DMRS shall be transmitted in the orphan REs using a 1-bit DCI field. In another example, the network entity may jointly indicate whether DMRS shall be transmitted in the orphan REs with DMRS ports indication via the DCI field antenna ports. In some aspects, the network entity may further indicate whether the orphan REs can be used for a PUSCH data transmission or not. In some other aspects, the network entity may further indicate whether the REs with the same subcarrier index(es) as the orphan REs can be used for PUSCH transmission or not. In some further aspects, the network entity can predefine whether the orphan REs can be used for PUSCH data transmission or not. In some other aspects, the network entity can predefine whether the REs with the same subcarrier index(es) as the orphan REs can be used for PUSCH transmission or not.

Referring to FIG. 6, at the beginning of the example scenario 600, the UE 102 may transmit 602 a UE capability report regarding uplink eType1/eType2 DMRS, similar to 302 discussed above. Similar to 304, the UE 102 receives 604 control signaling from the network entity to enable the uplink eType1/eType2 DMRS, and/or orphan RE handling scheme(s).

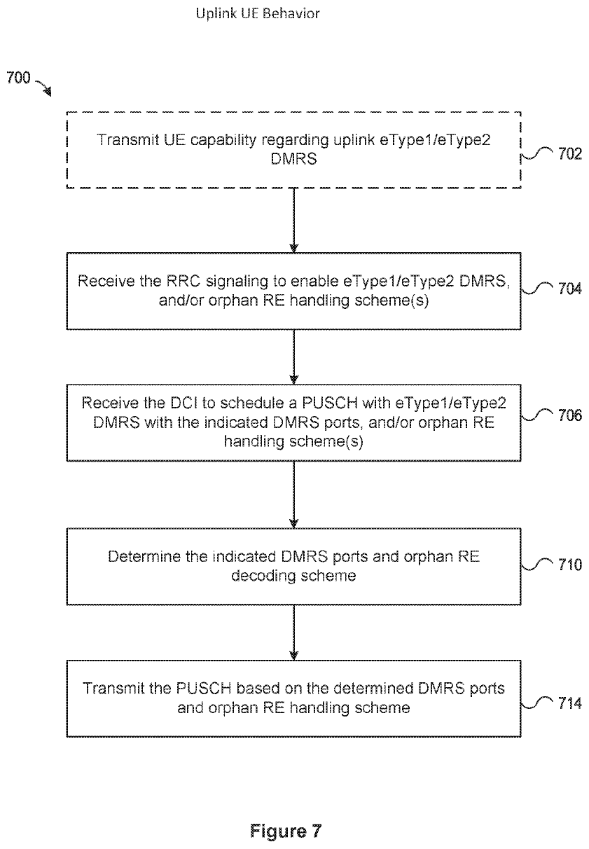

Next, the UE 102 receives 606 a DCI to schedule a PUSCH transmission using the indicated eType1/eType2 uplink DMRS ports and/or orphan RE handling scheme. Also similar to 310, the UE 102 determines 610 the indicated DMRS ports, and orphan RE handling scheme—but to generate the PUSCH transmission rather than receive a PDSCH message. The UE transmits PUSCH (e.g., PUSCH data) based on the DCI scheduling and DMRS-related indicators. The network entity might decode 616 the PUSCH signaling based on the selected orphan RE handling scheme for eType1/eType2 DMRS. FIG. 6 describes a signaling diagram for an uplink eType1 and eType2 DMRS configuration and resource mapping implementation, and FIG. 7 describes a method from a UE-side of the wireless communication link.

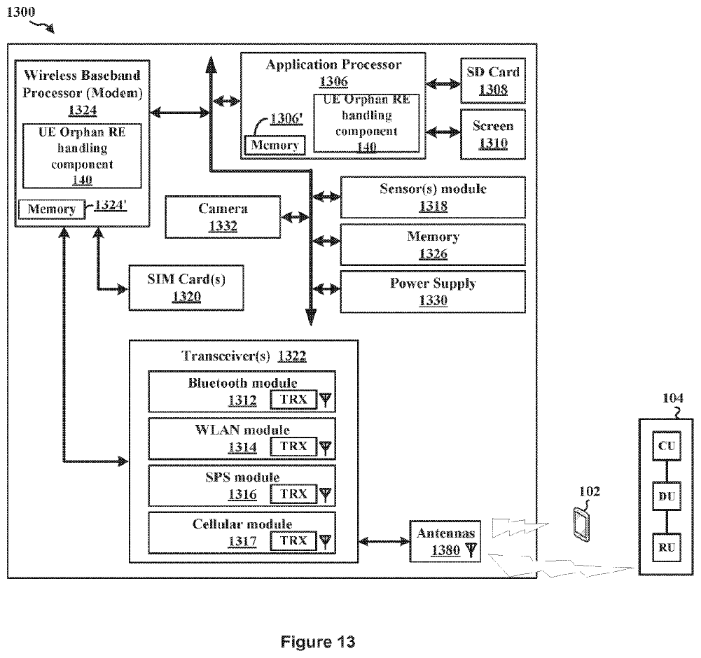

Now turning to FIG. 7 which illustrates an example method 700 for uplink eType1/eType2 DMRS configuration and resource mapping implemented in the UE. The method 700 can be implemented by UE 102 communicating with a network entity 104 depicted in FIG. 1. With reference to FIGS. 1 and 13, the method may be performed by the UE 102, the UE apparatus 1300, etc., which may include the memory 1324′ and which may correspond to the entire UE 102 or the UE apparatus 1300, or a component of the UE 102 or the UE apparatus 1300, such as the wireless baseband processor 1324, and/or the application processor 1306.

The method 700 begins at block 702 where the UE 102 may transmit a UE capability report message regarding uplink eType1/eType2 DMRS. For example, referring to FIG. 6, the UE 102 transmits 602 a UE capability report message regarding uplink eType1/eType2 DMRS.

Next, at block 704, the UE 102 receives RRC signaling to enable eType1/eType2 DMRS, and/or an indicator for at least one orphan RE handling scheme. For example, referring to FIG. 6, the UE 102 receives 604 an RRC reconfiguration message that includes an indication of eType1/eType2 DMRS and an indication of a first and second orphan RE handling scheme.

At block 706, the UE 102 receives a DCI to schedule a PUSCH transmission with eType1/eType2 DMRS with the indicated DMRS ports and/or orphan handling schemes. For example, referring to FIG. 6, the UE 102 receives 606 a DCI to schedule a PUSCH transmission with eType1/eType2 DMRS with the indicated DMRS ports and a first orphan handling scheme.

At block 710, the UE 102 might determine the indicated DMRS ports and orphan RE decoding scheme. For example, referring to FIG. 6, the UE 102 determines 610 the indicated DMRS ports and uses the first orphan RE handling scheme to generate the PUSCH transmission.

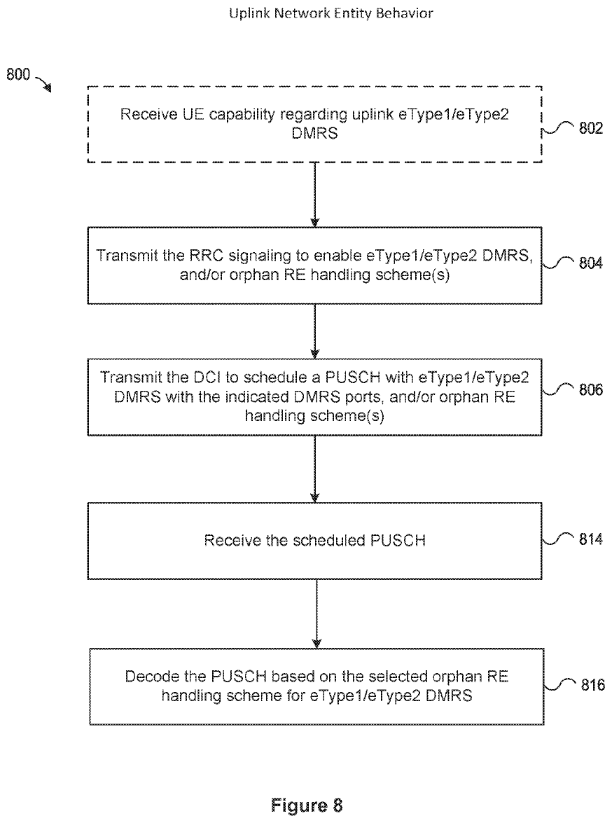

At block 714, the UE 102 transmits the PUSCH using the determined DMRS ports and first orphan RE decoding scheme. For example, referring to FIG. 6, the UE 102 transmits 614 the PUSCH message based on the determined DMRS ports and first orphan RE handling scheme. FIG. 7 describes a method from a UE-side of a wireless communication link, whereas FIG. 8 describes a method from a network-side of the wireless communication link.

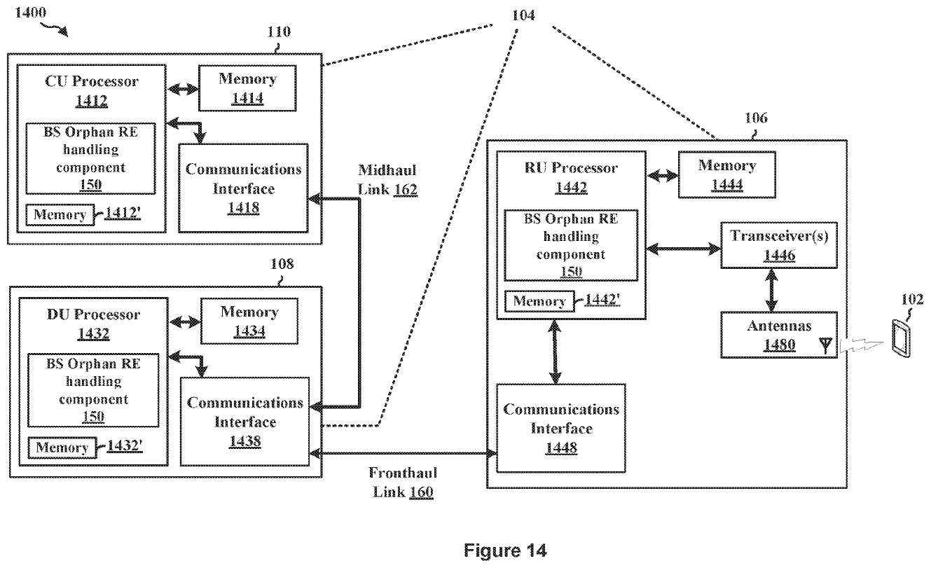

Now turning to FIG. 8 which illustrates an example method 800 for uplink Type1/eType2 DMRS configuration and resource mapping implemented in the network entity. With reference to FIGS. 1 and 14, the method may be performed by the base station or one or more network entities 104 at the base station, which may correspond to the RU 106, the DU 108, the CU 110, an RU processor 1442, a DU processor 1432, a CU processor 1412, etc. The base station or the one or more network entities 104 at the base station may include the memory 1412′/1432′/1442′, which may correspond to an entirety of the one or more network entities 104 or the base station.

Referring to FIG. 8, the method 800 begins at block 802 where the base station or the one or more network entities 104 at the base station may receive, from a UE 102, a UE capability report message regarding uplink eType1/eType2 DMRS. For example, the UE capability report message can represent 602 as shown in FIG. 6.

Next, at block 804, the network entity 104 transmits RRC signaling to enable eType1/eType2 DMRS, and/or at least one orphan RE handling scheme. For example, referring to FIG. 6, the network entity 104 transmits 604 an RRC reconfiguration message that includes an indication of eType1/eType2 DMRS and/or an indication of a first orphan RE handling scheme.

At block 806, the network entity 104 transmits the DCI to schedule a PUSCH transmission with eType1/eType2 DMRS with the indicated DMRS ports and/or orphan handling schemes. For example, referring to FIG. 6, the network entity 104 transmits 606 a DCI to schedule a PUSCH transmission with eType1/eType2 DMRS with the indicated DMRS ports and a first orphan handling scheme.

At block 814, the network entity 104 receives the scheduled PUSCH message which implements the selected orphan RE handling scheme. For example, referring to FIG. 6, the network entity 104 receives 614 the PUSCH based on the determined DMRS ports and first orphan RE handling scheme.

At block 816, the network entity 104 decodes the PUSCH message using the selected orphan RE handling scheme for eType1/eType2 DMRS if needed. For example, the network entity 104 decodes 616 the PUSCH based on the selected orphan RE handling scheme for eType1/eType2 DMRS.

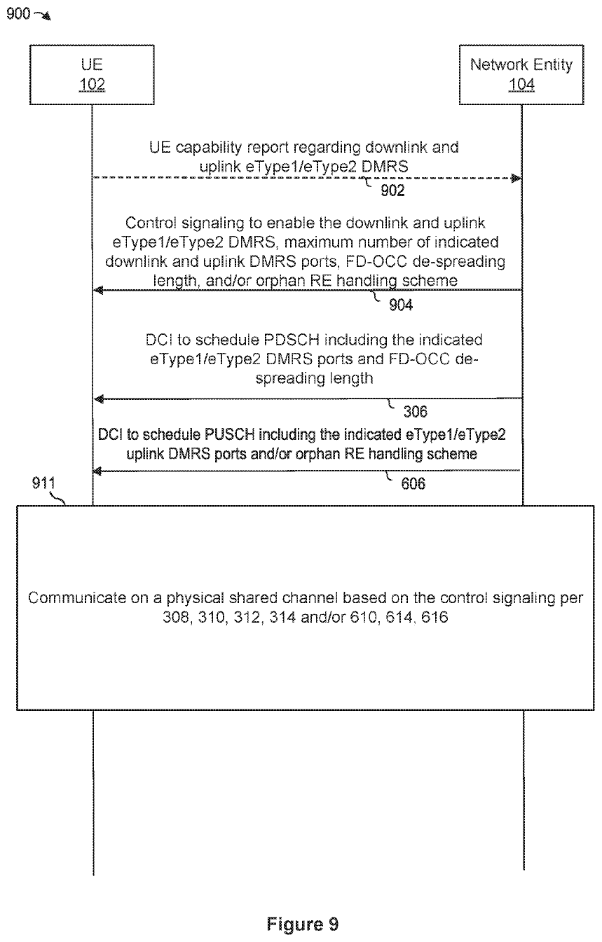

FIG. 3 describes a signaling diagram for downlink eType1 and eType2 DMRS configuration and resource mapping, FIG. 6 describes a signaling diagram for uplink eType1 and eType2 DMRS configuration and resource mapping, and FIG. 9 describes a signaling diagram for both uplink and downlink eType1 and eType2 DMRS configuration and resource mapping.

FIG. 9 illustrates a signaling diagram of an example scenario in which a UE and network entity exchange messages and implement procedures for uplink and downlink eType1 and eType2 DMRS configuration and resource mapping, according to some embodiments. The network entity 104 may correspond to the base station or an entity at the base station, such as the RU 106, the DU 108, the CU 110, etc. At the beginning of the example scenario 900, the UE 102 may transmit 602, to a serving network entity 104, a UE capability report regarding uplink eType1/eType2 DMRS, similar to 302 and 602 discussed above. Similar to 304, the UE 102 receives 604 control signaling from the network entity to enable the uplink eType1/eType2 DMRS, maximum number of indicated downlink DMRS ports, minimal FD-OCC de-spreading length, and/or orphan RE handling scheme. Next, the UE 102 receives 306 a DCI to schedule a PDSCH transmission. Also similar to 606, the UE receives 606 a DCI to schedule the PUSCH transmission. Then, the UE communicates 911 on a physical shared channel based on the control signaling per 308, 310, 312, 314 and/or 610, 614, 616.

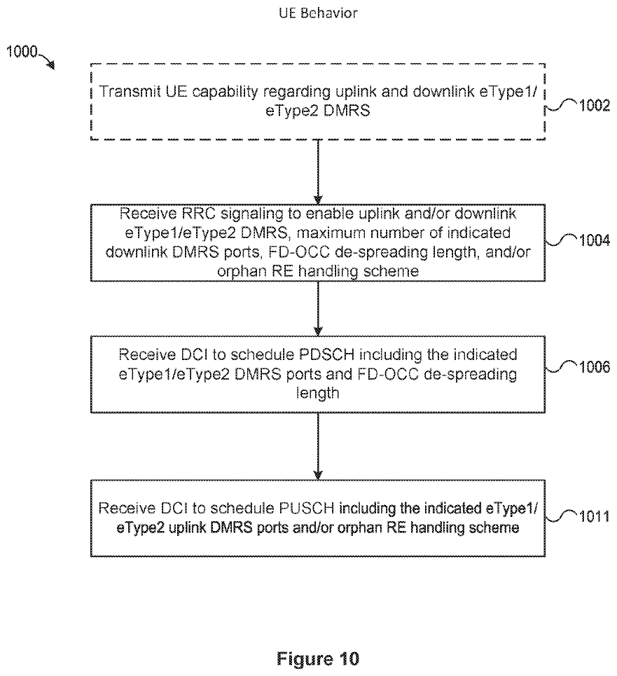

FIG. 9 describes a signaling diagram of an example scenario in which a UE and network entity exchange messages and implement procedures for uplink and downlink eType1 and eType2 DMRS configuration and resource mapping, whereas FIG. 10 describes a method of downlink and uplink eType1 and eType2 DMRS configuration and resource mapping from a UE-side of the wireless communication link.

Now turning to FIG. 10 which illustrates an example method 1000 for downlink and uplink eType1/eType2 DMRS configuration and resource mapping implemented in the UE. The method 1000 can be implemented by UE 102 and network entity 104 depicted in FIG. 1. With reference to FIGS. 1 and 13, the method may be performed by the UE 102, the UE apparatus 1300, etc., which may include the memory 1324′ and which may correspond to the entire UE 102 or the UE apparatus 1300, or a component of the UE 102 or the UE apparatus 1300, such as the wireless baseband processor 1324, and/or the application processor 1306.

Referring to FIG. 10, the method 1000 begins at block 1002 where the UE 102 may transmit a UE capability report message regarding uplink and downlink eType1/eType2 DMRS (events 302, 602, 902). For example, referring to FIG. 9, the UE 102 transmits 902 a UE capability report regarding uplink and downlink eType1/eType2 DMRS.

Next, at block 1004, the UE 102 receives RRC signaling to enable uplink and/or downlink eType1/eType2 DMRS, a maximum number of indicated downlink eType1/eType2 DMRS ports, a minimal FD-OCC dc-spreading length, and/or an indicator for at least one orphan RE handling scheme (events 304 and 604). For example, referring to FIG. 9, the UE 102 receives 904 control signaling to enable the downlink and uplink eType1/eType2 DMRS, a maximum number of indicated downlink and uplink DMRS ports, a minimal FD-OCC de-spreading length, and/or orphan RE handling scheme.

At block 1006, the UE 102 receives the DC to schedule PDSCH including the indicated eType1/eType2 DMRS ports and indicated FD-OCC de-spreading length. For example, referring to FIG. 3, the UE 102 receives 306 a DCI to schedule PDSCH scheduling information including the indicated eType1/eType2 DMRS ports and FD-OCC de-spreading length.

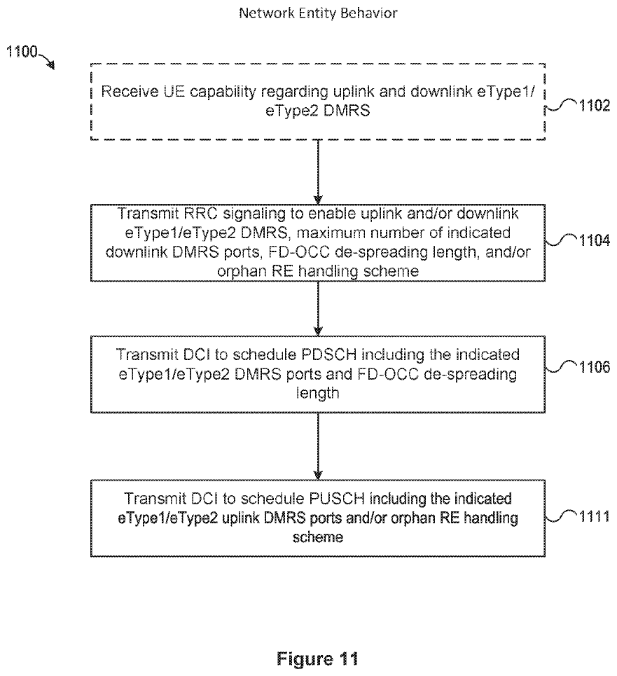

At block 1011, the UE 102 receives a DCI to schedule a PUSCH transmission using the indicated eType1/eType2 uplink DMRS ports and/or orphan RE handling schemes. For example, referring to FIG. 6, the UE 102 receives 606 a DC to schedule PUSCH messaging including the indicated eType1/eType2 uplink DMRS ports and a first orphan RE handling scheme. FIG. 10 describes a method from a UE-side of a wireless communication link, whereas FIG. 11 describes a method from a network-side of the wireless communication link.

Now turning to FIG. 11 which illustrates an example method 1100 for downlink and uplink eType1/eType2 DMRS configuration and resource mapping implemented in the network entity. The method 1100 can be implemented by UE 102 and network entity 104 depicted in FIG. 1. FIG. 11 is a flowchart 1100 of a method of wireless communication at a network entity. With reference to FIGS. 1 and 14, the method may be performed by the base station or one or more network entities 104 at the base station, which may correspond to the RU 106, the DU 108, the CU 110, an RU processor 1442, a DU processor 1432, a CU processor 1412, etc. The base station or the one or more network entities 104 at the base station may include the memory 1412′/1432′/1442′, which may correspond to an entirety of the one or more network entities 104 or the base station, or a component of the one or more network entities 104 or the base station, such as the RU processor 1442, the DU processor 1432, or the CU processor 1412.

The method 1100 begins at block 1102 where the base station or the one or more network entities 104 at the base station may receive a UE capability report message regarding uplink and downlink eType1/eType2 DMRS (events 302, 602, and 902). For example, referring to FIG. 9, the network entity 104 receives 902 a UE capability report indicating that the UE supports at least one of: a total number of eType1/eType2 DMRS antenna ports, a set of FD-OCC de-spreading lengths, or at least a first orphan RE handling scheme.

Next, at block 1104, the network entity 104 transmits RRC signaling to enable uplink and/or downlink eType1/eType2 DMRS, a maximum number of indicated downlink DMRS ports, a minimal FD-OCC de-spreading length, and/or one or more orphan RE handling schemes (events 304, 604, and 904). For example, referring to FIG. 9, the network entity 104 transmits 904 control signaling to enable the downlink and uplink eType1/eType2 DMRS, a maximum number of indicated downlink and uplink DMRS ports, a minimal FD-OCC de-spreading length, and/or one or more orphan RE handling scheme.

At block 1106, the network entity 104 transmits the DCI to schedule PDSCH including the indicated eType1/eType2 DMRS ports and FD-OCC de-spreading length. For example, referring to FIG. 3, the network entity 104 transmits 306 DCI to schedule PDSCH including the indicated eType1/eType2 DMRS ports and FD-OCC de-spreading length.

At block 1111, the network entity 104 transmits a DCI to schedule PUSCH including the indicated eType1/eType2 uplink DMRS ports and/or orphan RE handling scheme. For example, referring to FIG. 6, the network entity 104 transmits 606 a DC to schedule PUSCH transmission including the indicated eType1/eType2 uplink DMRS ports and a first orphan RE handling scheme.

In some aspects, when the network entity transmits the control signaling, the network entity might transmit an indication that the minimal FD-OCC spreading length value is greater than 2. When transmitting the DCI, the network entity might transmit the indicated FD-OCC de-spreading length equals to 4.

Aspects include orphan RE handling schemes that the UE can support for handling orphan REs. RRC signaling can include an indication which scheme is used.

In scheme 1 (default), the network entity shall always schedule even number of consecutive physical RBs (PRB) for PDSCH or PUSCH. The network entity may further schedule an even starting PRB or common resource block (CRB) index for each consecutive PRB block and/or for each precoding resource block group (PRG). The CRBs are indexes from the network entity perspective and the network entity indicates the CRB index for the first PRB index via RRC signaling. The network entity shall schedule the same co-schedule UEs within a PRG with the same precoder.

In scheme 2, the DMRSs in the orphan REs are not transmitted and the orphan REs are not available for data transmission. For example, referring to FIG. 2C, the orphan REs 252 are not available for data transmission. However, the REs 256 are available for data transmission.

In scheme 3, the DMRSs in the orphan REs are not transmitted and the orphan REs are used for data transmission. For example, referring to FIG. 2C, the orphan REs 252 are available for data transmission.

In scheme 4, the DMRSs in the orphan REs are not transmitted and the REs with the same subcarrier index(es) as the orphan REs in the transmission occasion are not used for data transmission. For example, referring to FIG. 2C, the entire subcarrier 254 is not available for data transmission.

FIG. 11 describes a method from a network-side of the wireless communication link, whereas FIGS. 12A-12B illustrate diagrams of an example of DMRS symbol locations for orphan REs.

FIG. 12A illustrates an orphan RE handling scheme that transmits DMRS in orphan REs. Diagram 1200 shows 3 FD-OCC de-spreading windows with a length 2. In this configuration, the DMRS in orphan REs is transmitted.

As shown in schemes 1200, 1210, the FD-OCC de-spreading length may determine whether the DMRSs in the orphan REs might be transmitted. For example, if the FD-OCC de-spreading length is less than 4, the DMRSs in the orphan REs are transmitted. If the FD-OCC de-spreading length is 4, scheme 1210 or 1220 can be applied. FIG. 12B illustrates an example for scheme 1220 which uses overlapping de-spreading windows.

FIG. 12B illustrates an orphan RE handling scheme 1220 that uses overlapping de-spreading windows. The DMRSs in the orphan REs are always transmitted in scheme 1220. When large FD-OCC length based de-spreading is needed, the receiver can use the neighbor DMRS REs in the same CDM group for FD-OCC de-spreading. For example, as shown in FIG. 12B, FD-OCC de-spreading window 1 may include REs 1, 2, 3, and 4 within CDM group 0. FD-OCC de-spreading window 2 may include REs 3, 4, 5, and 6 within CDM group 1. REs 3 and 4 are common REs to the windows 1 and 2 within CDM group 1.

For the above-described schemes 2, 3 and 4, the following sub-schemes may be used to determine the PT-RS transmission behavior.

Scheme A: The PT-RS is transmitted in REs having different subcarrier index(es) from the orphan REs.

Scheme B: The PT-RS is transmitted in the REs with the same subcarrier index(es) as the orphan REs. The receiver may perform frequency domain interpolation to identify the estimated channel in the orphan REs and then perform the phase offset calculation and compensation based on the PT-RS and the interpolated channel with the same subcarrier index.

Scheme C: The PT-RS is transmitted at the REs with the same subcarrier index as the a normal RE for the associated DMRS port in the RB.

Scheme D: The network entity may configure the resourceElementOffset in PTRS-UplinkConfig and PTRS-DownlinkConfig to make sure the PT-RS is not mapped to the REs with the same subcarrier index(es) as orphan REs.

FIGS. 12A-12B illustrate diagrams of an example of DMRS symbol locations for orphan REs, whereas FIGS. 12C-12G illustrate example tables of PT-RS RE offset configurations for eType1/eType2 DMRS.

FIG. 12C illustrates an example of PT-RS RE offset configuration 1230 for DM-RS antenna port 1231 within an RB. As shown in FIG. 12C, PT-RS RE offset configuration can be divided into DM-RS configuration eType1 1232 and PT-RS RE offset configuration eType2 1233. In DM-RS configuration eType1 1232, the PT-RS RE offset for eType1 is no more than 7. In DM-RS configuration eType2 1233, the PT-RS RE offset for eType2 is no more than 11. For DM-RS configuration eType1 1232, there are two CDM groups. The first CDM group 1234 may occupy subcarriers 0, 2, 4, 6. The second CDM group 1235 may occupy subcarriers 1, 3, 5, 7. There are 8 possible DM-RS antenna port 1231 (e.g., 1000, 1001, 1002, . . . ,1007). In DM-RS configuration eType2 1233, there are three CDM groups. The first CDM group 1234 may occupy subcarriers 0, 1, 6, 7. The second CDM group 1235 may occupy subcarriers 2, 3, 8, 9. The third CDM group 1236 occupies subcarriers 4, 5, 10, 11. There are 12 possible DM-RS antenna ports 1231 (e.g., 1000, 1001, 1002, . . . ,1011). The network entity can transmit resourceElementOffset as RRC signaling to the UE to communicate the PT-RS RE offset. For example, if the PT-RS RE Offset is associated with DM-RS antenna port 1000, the network entity can indicate offset00 to be 0, offset01 to be 2, offset10 to be 4, and offset11 to be 6. Table 1230 does not allow to indicate the PT-RS in the orphan REs. There is no 8 in the resourceElementOffset. Orphan REs often occur at the end of an RB (8^{th} or 10^{th} RE).

FIG. 12D illustrates another example of PT-RS RE offset configuration 1240 for DMRS antenna ports 1241 within an RB. As shown in FIG. 12D, PT-RS RE offset configurations can be divided into DMRS configuration eType1 1242 and PT-RS RE offset configuration eType2 1243. For DM-RS configuration eType1 1242, there are two CDM groups. The first CDM group 1244 may occupy subcarriers 0, 2, 4, 6. The second CDM group 1245 may occupy subcarriers 1, 3, 5, 7. There are 8 possible DM-RS antenna port 1241 (e.g., 1000, 1001, 1002, . . . ,1007) in eType1. In DM-RS configuration eType2 1243, there are three CDM groups. The first CDM group 1244 may occupy subcarriers 0, 1, 6, 7. The second CDM group 1235 may occupy subcarriers 2, 3, 8, 9. The third CDM group 1246 occupies subcarriers 4, 5, 10, 11. There are 12 possible DM-RS antenna port 1241 (e.g., 1000, 1001, 1002, . . . ,1011). This example depicts scheme B. Offsets 8 and 10 in resourceElementOffset cause PT-RS transmission at REs in the same subcarrier index(es) as orphan REs. Such indication can be used for the situations without orphan REs.

The candidate number of indicated ports (see FIG. 12G) for downlink eType1/eType2 DMRS and the maximum number of indicated ports (see FIG. 12F) for downlink eType1/eType2 DMRS may be used to reduce an overhead of the DCI for eType1/eType2 DMRS port indication. When the network entity configures the candidate number of indicated ports or the maximum number of indicated ports, the size of the DCI field may be determined based on a sum of the number of codepoints for the candidate number of indicated ports. The orphan RE handling scheme(s) for uplink and downlink eType1/eType2 DMRS shall select at least one from the subset of or all the schemes 2 to 6 as described in FIGS. 2C, 12A, and 12B above.

In some aspects, the RRC signaling may further include one scrambling ID for generating eType1/eType2 DMRS sequence. Alternatively, the RRC signaling may further include more than one scrambling ID for the eType1/eType2 DMRS sequence generation, where a scrambling ID is used for the sequence generation for a CDM group for the eType1/eType2 DMRS. For example, a first scrambling ID is used with a first CDM group and a second scrambling ID is used for a second CDM group. The scrambling ID technique may result in Peak Average Power Ratio (PAPR) reduction.

In an aspect, the network entity may indicate a minimal FD-OCC de-spreading length for downlink eType1/eType2 DMRS via a DCI (e.g., DCI format 1_1/1_2) for flexible scheduling. For example, the candidate minimal FD-OCC de-spreading length can be {1, 2, 4} or {1, 4} for a FD-OCC-4 based eType1/eType2 DMRS. In another example, the candidate minimal FD-OCC de-spreading length can be {1, 3, 6} or {1, 6} for a FD-OCC-6 based eType1/eType2 DMRS. The network entity may indicate the minimal FD-OCC de-spreading length per CDM group or across CDM groups.

The UE can determine the FD-OCC de-spreading length for a CDM group based on the indicated minimal FD-OCC de-spreading length and the number of indicated DMRS ports for the CDM group. The FD-OCC de-spreading length for a CDM group is the maximum value of: (a) indicated minimal FD-OCC de-spreading length and (b) the minimal FD-OCC de-spreading length to decode number of indicated DMRS ports for the CDM group. In one example, if minimal FD-OCC de-spreading length is 1, and the number of indicated DMRS ports in the CDM group is 2, which requires the UE to perform FD-OCC de-spreading length 2 to distinguish the 2 DMRS ports, the FD-OCC de-spreading length shall be 2. In another example, if minimal FD-OCC de-spreading length is 1, and the number of indicated DMRS ports in the CDM group is 3, which requires the UE to perform FD-OCC de-spreading length 4 to distinguish the 3 DMRS ports, the FD-OCC de-spreading length should be 4.

In some aspects, the network entity may indicate the minimal FD-OCC de-spreading length using an independent DCI field. In one example, the DCI field may take 1 bit, which indicates whether the minimal FD-OCC de-spreading length is 1 or the FD-OCC length for the scheduled eType1/eType2 DMRS. In another example, the DCI field may take more than 1 bits, which indicates the minimal FD-OCC de-spreading length. In another example, the network entity can use a first 1-bit DCI field to indicate whether the minimal FD-OCC de-spreading length is 1 or the FD-OCC length for the scheduled DMRS, and a second 1-bit DCI field to indicate whether to use Type1/Type2 DMRS or eType1/eType2 DMRS.

In some aspects, the network entity may indicate the minimal FD-OCC de-spreading length and DMRS port(s) jointly by a single DCI field, for example, antenna port. In one example, for some candidate value(s) of antenna port, the network entity may indicate whether the minimal FD-OCC de-spreading length is 1 or the FD-OCC length. In one example, for some candidate value(s) of antenna port, the network entity may indicate the minimal FD-OCC de-spreading length. For some other candidate value(s) of antenna port without minimal FD-OCC de-spreading length related indication, the FD-OCC de-spreading length should be the same as the FD-OCC length. The benefit of indicating the minimal FD-OCC de-spreading length and DMRS port(s) jointly by a single DCI field can maintain DCI overhead.

FIG. 12E illustrates one example for joint indication of DMRS ports and minimal FD-OCC de-spreading length. This example is for eType1 DMRS with one front-loaded symbol. The ports {0, 1, 2, 3} are from the first CDM group and ports {4, 5, 6, 7} are from the second CDM group. Table 1250 is a modification of Table 7.3.1.2.2-2 in 3GPP 38.212. For example, table 1250 includes a new column “Minimal FD-OCC de-spreading length” 1251. In table 1250, two DMRS port 0, 1 (value 7 and 8) can have a different minimal FD-OCC de-spreading length.

In some aspects, the UE may determine the minimal FD-OCC de-spreading length based on the indicated DMRS port(s). In one example, if the number of indicated DMRS port(s) is more than X, the minimal FD-OCC de-spreading length is 1, where X may be predefined, e.g. X=3 or 4. The network entity may configure X by higher layer signaling (e.g. RRC or MAC Control Element (CE)). Alternatively, the network entity may dynamically configure X via DCI. If the number of indicated DMRS port(s) is less than or equal to X, the minimal FD-OCC de-spreading length is the same as the FD-OCC length. In another example, the network entity may indicate the minimal FD-OCC de-spreading length for each number of indicated DMRS port(s) via RRC signaling. For example, the network entity may indicate the minimal FD-OCC de-spreading length to be 2 for port 1 and to be 4 for port 2. The UE shall apply corresponding minimal FD-OCC de-spreading length to identify the FD-OCC de-spreading length to decode DMRS after the UE receives the scheduling DCI with indicated DMRS port(s). In another example, the network entity may indicate whether the minimal FD-OCC de-spreading length shall be 1 or more than 1 (i.e. whether there is any co-scheduled UEs) for each number of indicated DMRS port(s) via RRC signaling. For example, network entity may use one-bit indication to indicate to determine FD-OCC 4 or FD-OCC 1.

In an aspect, the network entity may indicate the downlink/uplink eType1/eType2 DMRS ports by DCI (e.g., DCI format 1_1/1_2) based on the maximum number of indicated downlink/uplink DMRS ports. Network entity may configure the maximum number of indicated downlink/uplink DMRS ports by RRC signaling or MAC CE. Network entity may configure the candidate maximum number of indicated downlink/uplink DMRS ports by RRC signaling or MAC CE. The payload size for the DCI field antenna ports for eType1/eType2 DMRS may be determined based on the maximum number of indicated DMRS ports or candidate number of indicated DMRS ports configured by the network entity. If dynamic switching between eType1/eType2 DMRS and Type1/Type2 DMRS is enabled, e.g. the network entity configures an RRC parameter to enable the dynamic switching or a separate DCI field is used to indicate whether the DMRS is based on Type 1/Type2 DMRS or eType1/eType2 DMRS, the payload size for the DCI field antenna ports may be based on the maximum number of codepoints for eType1/eType2 DMRS and Type 1/Type2 DMRS.

FIG. 12F illustrates an example of eType1 DMRS ports indication with single front-loaded symbol and maximum number of indicated ports is 1. Table 1260 is a modification of 3GPP 38.212 Table 7.3.1.2.2-1. Table 1260 may indicate to the UE that the maximum number of indicated ports is 1. DMRS ports may include entries with 1 port indication. That means 4-bit is needed to indicate the DMRS ports. This can result in overhead saving in DMRS ports indication.

FIG. 12G illustrates an example for eType1 DMRS ports indication with single front-loaded symbol and the candidate number of indicated ports is {1, 2, 4}. Table 1270 is a modification of 3GPP 38.212 Table 7.3.1.2.2-1.

A UE apparatus 1300, as described in FIG. 13, may perform the method of flowchart 400, 700, 1000. The base station or the one or more network entities 104 at the base station, as described in FIG. 14, may perform the method of flowchart 500, 800, 1100.

FIG. 13 is a diagram 1300 illustrating an example of a hardware implementation for a UE apparatus 1300. The apparatus 1300 may be the UE 102, a component of the UE, or may implement UE functionality. In some aspects, the apparatus 1300 may include a wireless baseband processor 1324 (also referred to as a modem) coupled to one or more transceivers 1322 (e.g., wireless RF transceiver). The wireless baseband processor 1324 may include on-chip memory 1324′. In some aspects, the apparatus 1300 may further include one or more subscriber identity modules (SIM) cards 1320 and an application processor 1306 coupled to a secure digital (SD) card 1308 and a screen 1310. The application processor 1306 may include on-chip memory 1306′.

The apparatus 1300 may further include a Bluetooth module 1312, a WLAN module 1314, an SPS module 1316 (e.g., GNSS module), and a cellular module 1317 within the one or more transceivers 1322. The Bluetooth module 1312, the WLAN module 1314, the SPS module 1316, and the cellular module 1317 may include an on-chip transceiver(TRX) (or in some cases, just a receiver (RX)). The Bluetooth module 1312, the WLAN module 1314, the SPS module 1316, and the cellular module 1317 may include their own dedicated antennas and/or utilize the antennas 1380 for communication. The apparatus 1300 may further include one or more sensor modules 1318 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional modules of memory 1326, a power supply 1330, and/or a camera 1332.

The wireless baseband processor 1324 communicates through the transceiver(s) 1322 via one or more antennas 1380 with another UE 102 and/or with an RU associated with a network entity 104. The wireless baseband processor 1324 and the application processor 1306 may each include a computer-readable medium/memory 1324′, 1306′, respectively. The additional modules of memory 1326 may also be considered a computer-readable medium/memory. Each computer-readable medium/memory 1324′, 1306′, 1326 may be non-transitory. The wireless baseband processor 1324 and the application processor 1306 are each responsible for general processing, including the execution of software stored on the computer-readable medium/memory. The software, when executed by the wireless baseband processor 1324/application processor 1306, causes the wireless baseband processor 1324/application processor 1306 to perform the various functions described. The computer-readable medium/memory may also be used for storing data that is manipulated by the wireless baseband processor 1324/application processor 1306 when executing software. The wireless baseband processor 1324/application processor 1306 may be a component of the UE 102. The apparatus 1300 may be a processor chip (modem and/or application) and include just the wireless baseband processor 1324 and/or the application processor 1306, and in another configuration, the apparatus 1300 may be the entire UE 102 and include the additional modules of the apparatus 1300.

As discussed, the UE Orphan RE handling component 140 is configured to receive, from a network entity, control signaling that causes the UE to enable at least one of: a number of eType1 or eType2 DMRS antenna ports, a minimum FD-OCC de-spreading length, or at least one orphan RE handling scheme; receive, from the network entity, DCI that schedules a physical shared channel for at least one of: at least one indicated eType1/eType2 DMRS antenna port, an indicated FD-OCC de-spreading length, or an indicated orphan RE handling scheme; and communicate with the network entity on the physical shared channel based on at least one of: the at least one indicated eType1/eType2 DMRS antenna port, the indicated FD-OCC de-spreading length, or the indicated orphan RE handling scheme. The UE Orphan RE handling component 140 may be within the wireless baseband processor 1324, the application processor 1306, or both the wireless baseband processor 1324 and the application processor 1306. The UE Orphan RE handling component 140 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 1300 may include a variety of components configured for various functions. In one configuration, the apparatus 1300, and in particular the wireless baseband processor 1324 and/or the application processor 1306, includes means for receiving, from a network entity, control signaling that causes the UE to enable at least one of: a number of eType1 or eType2 DMRS antenna ports, a minimum FD-OCC de-spreading length, or at least one orphan RE handling scheme; means for receiving, from the network entity, DCI that schedules a physical shared channel for at least one of: at least one indicated eType1/eType2 DMRS antenna port, an indicated FD-OCC de-spreading length, or an indicated orphan RE handling scheme; and means for communicating with the network entity on the physical shared channel based on at least one of: the at least one indicated eType1/eType2 DMRS antenna port, the indicated FD-OCC de-spreading length, or the indicated orphan RE handling scheme. The apparatus 1300 further includes means for transmitting, to the network entity, a UE capability report indicating that the UE supports at least one of a total number of eType1/eType2 DMRS antenna ports, a set of FD-OCC de-spreading lengths, or at least a first orphan RE handling scheme. The means may be the UE Orphan RE handling component 140 of the apparatus 1300 configured to perform the functions recited by the means.

FIG. 14 is a diagram 1400 illustrating an example of a hardware implementation for one or more network entities 104. The one or more network entities 104 may be a BS, a component of a BS, or may implement BS functionality. The one or more network entities 104 may include at least one of a CU 1410, a DU 1430, or an RU 1440. For example, the component 199 may sit at the one or more network entities 104, such as the CU 1410; both the CU 1410 and the DU 1430; each of the CU 1410, the DU 1430, and the RU 1440; the DU 1430; both the DU 1430 and the RU 1440; or the RU 1440.

The CU 1410 may include a CU processor 1412. The CU processor 1412 may include on-chip memory 1412′. In some aspects, the CU 1410 may further include additional memory modules 1414 and a communications interface 1418. The CU 1410 communicates with the DU 1430 through a midhaul link 162, such as an F1 interface. The DU 1430 may include a DU processor 1432. The DU processor 1432 may include on-chip memory 1432′. In some aspects, the DU 1430 may further include additional memory modules 1434 and a communications interface 1438. The DU 1430 communicates with the RU 1440 through a fronthaul link 160. The RU 1440 may include an RU processor 1442. The RU processor 1442 may include on-chip memory 1442′. In some aspects, the RU 1440 may further include additional memory modules 1444, one or more transceivers 1446, antennas 1480, and a communications interface 1448. The RU 1440 communicates wirelessly with the UE 102.

The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed, the BS Orphan RE handling component 150 configured to transmitting, to a UE, control signaling that causes the UE to enable at least one of: a number of eType1 or eType2 DMRS antenna ports, a minimum FD-OCC de-spreading length, or at least one orphan RE handling scheme; transmit, to the UE, DCI that schedules a physical shared channel for the at least one of: the eType1 DMRS, at least one indicated eType1/eType2 DMRS antenna port, an indicated FD-OCC de-spreading length, or an indicated orphan RE handling scheme; and communicate with the UE on the physical shared channel based on at least one of: the at least one indicated eType1/eType2 DMRS antenna ports, the indicated FD-OCC de-spreading length, or the indicated orphan RE handling scheme. The BS Orphan RE handling component 150 may be within one or more processors of one or more of the CU 1410, DU 1430, and the RU 1440. The BS Orphan RE handling component 150 may be one or more hardware components specifically configured to carry out the stated processes/algorithm, implemented by one or more processors configured to perform the stated processes/algorithm, stored within a computer-readable medium for implementation by one or more processors, or some combination thereof.

The one or more network entities 104 may include a variety of components configured for various functions. In one configuration, the one or more network entities 104 includes means for transmitting, to a UE, control signaling that causes the UE to enable at least one of: a number of eType1 or eType2 DMRS antenna ports, a minimum FD-OCC de-spreading length, or at least one orphan RE handling scheme; transmitting, to the UE, DCI that schedules a physical shared channel for the at least one of: the eType1 DMRS, at least one indicated eType1/eType2 DMRS antenna port, an indicated FD-OCC de-spreading length, or an indicated orphan RE handling scheme; and communicating with the UE on the physical shared channel based on at least one of: the at least one indicated eType1/eType2 DMRS antenna ports, the indicated FD-OCC de-spreading length, or the indicated orphan RE handling scheme. The apparatus 1400 further includes means receiving, from the UE, a UE capability report indicating that the UE supports at least one of: a total number of eType1/eType2 DMRS antenna ports, a set of FD-OCC de-spreading lengths, or at least a first orphan RE handling scheme. The means may be the BS Orphan RE handling component 150 of the one or more network entities 104 configured to perform the functions recited by the means.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. Unless specifically stated otherwise, the term “some” refers to one or more. Combinations such as “at least one of A, B, or C” or “one or more of A, B, or C” include any combination of A. B, and/or C, such as A and B, A and C, B and C, or A and B and C, and may include multiples of A, multiples of B, and/or multiples of C. or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term.

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: receiving, from a network entity, control signaling that causes the UE to enable at least one of: a number of enhanced Type1 (eType1) or eType2 demodulation reference signal (DMRS) antenna ports, a minimal frequency-domain orthogonal cover code (FD-OCC) dc-spreading length, or at least one orphan resource element (RE) handling scheme; receiving, from the network entity, downlink control information (DCI) that schedules a physical shared channel for at least one of: at least one indicated eType1/eType2 DMRS antenna port, an indicated minimal FD-OCC de-spreading length, or an indicated orphan RE handling scheme; and communicating with the network entity on the physical shared channel based on at least one of: the at least one indicated eType1/eType2 DMRS antenna port, the indicated FD-OCC de-spreading length, or the indicated orphan RE handling scheme.

Example 2 may be combined with example 1 and further includes transmitting, to the network entity, a UE capability report indicating that the UE supports at least one of: a total number of eType1/eType2 DMRS antenna ports, a set of FD-OCC de-spreading lengths, or at least a first orphan RE handling scheme.

Example 3 may be combined with any of examples 1-2 and includes the physical shared channel is a physical uplink shared channel (PUSCH).

Example 4 may be combined with any of examples 1-2 and includes that the receiving the control signaling further includes: receiving an indication that the minimum FD-OCC spreading length value is greater than 2; and includes that the receiving the DCI includes: receiving the minimal indicated FD-OCC de-spreading length equals to 4.

Example 5 may be combined with example 4 and includes that the receiving the control signaling further includes: receiving an indicator for the at least one orphan RE handling scheme.

Example 6 may be combined with any of examples 1-2 and includes the physical shared channel is a physical downlink shared channel (PDSCH).

Example 7 may be combined with example 6 and includes that the receiving the control signaling further includes: receiving an indicator for the at least one orphan RE handling scheme.

Example 8 may be combined with any of examples 1-7 and includes that the receiving the control signaling further includes: receiving the control signaling through a radio resource control (RRC) message.

Example 9 may be combined with any of examples 1-8 and includes that the communicating with the network entity further includes: refraining from transmitting the DMRS in orphan REs; and refraining from using orphan REs for data transmission.

Example 10 may be combined with any of examples 1-9 and includes that the communicating with the network entity further includes: refraining from transmitting the DMRS in orphan REs; and refraining from using subcarriers of orphan REs for a phase tracking reference signal (PT-RS).

Example 11 may be combined with any of examples 1-10 and includes that the communicating with the network entity further includes: shifting a first PT-RS from a subcarrier of orphan REs to a subcarrier.

Example 12 may be combined with any of examples 1-11 and includes that the communicating with the network entity further includes: shifting a second PT-RS to a second subcarrier different from orphan REs.

Example 13 may be combined with any of examples 1-8 and includes that the communicating with the network entity further includes: transmitting the DMRS in the orphan REs; and using neighboring DMRS REs for FD-OCC de-spreading.

Example 14 may be combined with any of examples 6-8 and includes that the receiving, from the network entity the DCI further includes: receiving an indication of the transmitting or refraining from transmitting the DMRS in the orphan REs.

Example 15 may be combined with any of examples 6-8 and includes that the receiving the control signaling further includes: receiving, from the network entity, an indication that the network entity does not transmit a phase tracking reference signal (PT-RS) on REs having a same subcarrier index as the orphan REs.

Example 16 may be combined with any of examples 6-8 and includes that the receiving the control signaling further includes: receiving, from the network entity, an indication that the network entity transmits a PT-RS on REs having a same subcarrier index as the orphan REs.

Example 17 is an apparatus for wireless communication for implementing a method as in any of examples 1-16.

Example 18 is a non-transitory computer-readable medium storing computer executable code, the code when executed by at least one processor causes the at least one processor to implement a method as in any of examples 1-16.

Example 19 is a method of wireless communication at a network entity, including: transmitting, to a user equipment (UE), control signaling that causes the UE to enable at least one of: a number of enhanced Type1 (eType1) or eType2 demodulation reference signal (DMRS) antenna ports, a minimum FD-OCC de-spreading length, or at least one orphan resource element (RE) handling scheme; transmitting, to the UE, downlink control information (DCI) that schedules a physical shared channel for at least one of: at least one indicated eType1/eType2 DMRS antenna port, an indicated minimal FD-OCC de-spreading length, or an indicated orphan RE handling scheme; and communicating with the UE on the physical shared channel based on at least one of: the at least one indicated eType1/eType2 DMRS antenna port, the indicated FD-OCC de-spreading length, or the indicated orphan RE handling scheme.

Example 20 may be combined with example 19 and further includes receiving, from the UE, a UE capability report indicating that the UE supports at least one of: a total number of eType1/eType2 DMRS antenna ports, a set of FD-OCC de-spreading lengths, or at least a first orphan RE handling scheme.

Example 21 may be combined with example 19-20 and includes the physical shared channel is a physical uplink shared channel (PUSCH).

Example 22 may be combined with example 19-20 and includes that the transmitting the control signaling further includes: transmitting an indication that the minimum FD-OCC spreading length value is greater than 2; and includes that transmitting the DCI includes: transmitting the indicated FD-OCC de-spreading length equals to 4.

Example 23 may be combined with example 22 and includes that the transmitting the control signaling further includes: transmitting an indicator for the at least one orphan RE handling scheme.

Example 24 may be combined with example 19 and includes the physical shared channel is a physical downlink shared channel (PDSCH).

Example 25 may be combined with example 24 and includes that the transmitting the control signaling further includes: transmitting an indicator for the at least one orphan RE handling scheme.

Example 26 may be combined with example 19-25 and includes that the transmitting the control signaling further includes: transmitting the control signaling using a radio resource control (RRC) message.

Example 27 may be combined with example 19-26 and includes that the communicating with the UE further includes: transmitting an indication, to the UE, to refrain from transmitting the DMRS on the orphan REs; and transmitting an indication, to the UE, to refrain from using the orphan REs for data transmission.

Example 28 may be combined with example 19-27 and includes that the transmitting the control signaling further includes: transmitting an indication, to the UE, to refrain from transmitting the DMRS on the orphan REs; and transmitting an indication, to the UE, to refrain from using REs having a same subcarrier index as the orphan REs for data transmission.

Example 29 may be combined with example 19-28 and includes that the transmitting the control signaling further includes: transmitting an indication, to the UE, to transmit the DMRS on the orphan REs; and using neighboring DMRS REs for FD-OCC de-spreading.

Example 30 may be combined with example 24-26 and includes that the transmitting the control signaling further includes: refraining from transmitting the DMRS on the orphan REs; and transmitting an indication, to the UE, to refrain from using the orphan REs for data transmission.

Example 31 may be combined with example 24-26 and includes that the transmitting the control signaling further includes: transmitting an indication, to the UE, to use the orphan REs for data transmission.

Example 32 may be combined with example 24-26 and includes that the transmitting the control signaling further includes: refraining from transmitting DMRS on the orphan REs; and transmitting an indication, to the UE, to refrain from using REs having a same subcarrier index as the orphan REs for data transmission.

Example 33 may be combined with example 24-26 and includes that the transmitting the control signaling further includes: determining whether the DMRS on the orphan REs is transmitted based on the FD-OCC de-spreading length.

Example 34 may be combined with example 25-26 and includes that the transmitting the control signaling further includes: transmitting the DMRS on the orphan REs; and using neighboring DMRS REs for FD-OCC de-spreading.

Example 35 may be combined with example 24-26 and includes that the transmitting the control signaling further includes: refraining from transmitting a phase tracking reference signal (PT-RS) on REs having a same subcarrier index as the orphan REs.

Example 36 may be combined with example 24-26 and includes that the transmitting the control signaling further includes: transmitting a PT-RS on REs having a same subcarrier index as the orphan REs.

Example 37 is an apparatus for wireless communication for implementing a method as in any of examples 1-36.

Example 38 is an apparatus for wireless communication including means for implementing a method as in any of examples 1-36.

Example 39 is a non-transitory computer-readable medium storing computer executable code, the code when executed by at least one processor causes the at least one processor to implement a method as in any of examples 1-36.

1-38. (canceled)

39. A method of wireless communication at a user equipment (UE), comprising:
receiving, from a network entity, a demodulation reference signal (DMRS) configuration for at least one of: a number of enhanced Type1 (eType1) or eType2 DMRS antenna ports, a minimal frequency-domain orthogonal cover code (FD-OCC) de-spreading length, or at least one orphan resource element (RE) handling scheme;
receiving, from the network entity, downlink control information (DCI) that schedules a physical shared channel for at least one of: at least one indicated eType1/eType2 DMRS antenna port, an indicated minimal FD-OCC de-spreading length based on at least one indicated DMRS antenna port, or an indicated orphan RE handling scheme; and
communicating with the network entity on the physical shared channel based on at least one of: the at least one indicated eType1/eType2 DMRS antenna port, the indicated minimal FD-OCC de-spreading length, or the indicated orphan RE handling scheme.

40. The method of claim 39, further comprising:
transmitting, to the network entity, a UE capability report indicating that the UE supports at least one of: an eType/eType2 DMRS, a total number of eType1/eType2 DMRS antenna ports, or at least a first orphan RE handling scheme.

41. The method of claim 39, wherein the physical shared channel is a physical uplink shared channel (PUSCH).

42. The method of claim 39, wherein the receiving the DMRS configuration comprises:
receiving an indication that a minimal FD-OCC de-spreading length value is greater than 2; and
wherein the receiving the DCI comprises:
receiving the indicated minimal FD-OCC de-spreading length equals to 4.

43. The method of claim 39, wherein the physical shared channel is a physical downlink shared channel (PDSCH).

44. The method of claim 39, wherein the communicating with the network entity comprises:
refraining from transmitting the DMRS in orphan REs; and
refraining from using orphan REs for data transmission.

45. The method of claim 39, wherein the DMRS configuration indicates a maximum number of the at least one indicated eType1/eType2 DMRS antenna port.

46. The method of claim 43, wherein the receiving, from the network entity, the DCI comprises:
receiving an indication of transmitting or refraining from transmitting the DMRS in orphan REs.

47. The method of claim 43, wherein the receiving the DMRS configuration comprises:
receiving, from the network entity, an indication that the network entity transmits a phase tracking reference signal (PT-RS) on REs having a same subcarrier index as orphan REs.

48. The method of claim 39, wherein the DMRS configuration includes at least one or more scrambling identifications, IDs, for generating an eType1/eType2 DMRS sequence.

49. A method of wireless communication at a network entity, comprising:
transmitting, to a user equipment (UE), a demodulation reference signal (DMRS) configuration for at least one of: a number of enhanced Type1 (eType1) or eType2 DMRS antenna ports, a minimal FD-OCC de-spreading length, or at least one orphan resource element (RE) handling scheme;
transmitting, to the UE, downlink control information (DCI) that schedules a physical shared channel for at least one of: at least one indicated eType1/eType2 DMRS antenna port, an indicated minimal FD-OCC de-spreading length based on at least one indicated DMRS antenna port, or an indicated orphan RE handling scheme; and
communicating with the UE on the physical shared channel based on at least one of: the at least one indicated eType1/eType2 DMRS antenna port, the indicated minimal FD-OCC de-spreading length, or the indicated orphan RE handling scheme.

50. The method of claim 49, further comprising:
receiving, from the UE, a UE capability report indicating that the UE supports at least one of: an eType1/eType2 DMRS, a total number of eType1/eType2 DMRS antenna ports, or at least a first orphan RE handling scheme.

51. The method of claim 49, wherein the physical shared channel is a physical downlink shared channel (PDSCH).

52. The method of claim 51, further comprising:
scheduling an even number of consecutive physical resource blocks (PRBs) for the PDSCH and an even starting PRB for each consecutive PRB block.

53. The method of claim 49, wherein the DCI indicates:
whether there is any co-scheduled UE, and
scheduled eType1/eType2 DMRS antenna ports.

54. An apparatus for wireless communication at a user equipment (UE), comprising:
a transceiver;
a memory; and
a processor coupled to the memory and the transceiver, the processor configured to:
receive, from a network entity, a demodulation reference signal (DMRS) configuration for at least one of: a number of enhanced Type1 (eType1) or eType2 DMRS antenna ports, a minimal frequency-domain orthogonal cover code (FD-OCC) de-spreading length, or at least one orphan resource element (RE) handling scheme;
receive, from the network entity, downlink control information (DCI) that schedules a physical shared channel for at least one of: at least one indicated eType1/eType2 DMRS antenna port, an indicated minimal FD-OCC de-spreading length based on at least one indicated DMRS antenna port, or an indicated orphan RE handling scheme; and
communicate with the network entity on the physical shared channel based on at least one of: the at least one indicated eType1/eType2 DMRS antenna port, the indicated minimal FD-OCC de-spreading length, or the indicated orphan RE handling scheme.

55. The apparatus of claim 54, wherein the processor is further configured to:
transmit, to the network entity, a UE capability report indicating that the UE supports at least one of: an eType1/eType2 DMRS, a total number of eType1/eType2 DMRS antenna ports, or at least a first orphan RE handling scheme.

56. The apparatus of claim 54, wherein the DMRS configuration indicates a maximum number of the at least one indicated eType1/eType2 DMRS antenna port.

57. The apparatus of claim 54, wherein the DMRS configuration includes at least one or more scrambling identifications, IDs, for generating an eType1/eType2 DMRS sequence.

58. The apparatus of claim 54, wherein the DCI indicates:
whether there is any co-scheduled UE, and
scheduled eType1/eType2 DMRS antenna ports.
